(19) United States
(12) Patent Application Publication
(10) Pub. No.: US 2005/0222772 A1
(43) Pub. Date: Oct. 6, 2005

(54) Oil rig choke control systems and methods

(76) Inventors: William L. Koederitz, Cedar Park, TX (US); Mallappa I. Guggari, Cedar Park, TX (US)

Correspondence Address: Guy McClung, PMB 347, 16690 Champion Forest Drive, Spring, TX, 77379-7023, US

(21) Appl. No.: 11/056,951

(22) Filed: Feb. 11, 2005

Related U.S. Application Data
(63) Continuation-in-part of application No. 10/373,216, filed on Feb. 24, 2003, now Pat. No. 6,907,375.
(63) Continuation-in-part of application No. 10/353,650, filed on Jan. 29, 2003, now Pat. No. 6,920,942.
(60) Provisional application No. 60/546,241, filed on Feb. 20, 2004.

(51) Int. Cl. G06F 19/00

(52) U.S. Cl. 702/6

(57) ABSTRACT

A choke diagnostic system with a positioner for moving a choke mechanism of a choke, a choke isolation valve for placing the choke in standby mode, and a processor controlling the choke and, in certain aspects, the processor for commanding the positioner to move the choke mechanism while the choke is in standby mode.

### RELATED APPLICATIONS

This is a continuation-in-part of U.S. application Ser. No. 10/373,216 filed Feb. 24, 2003; 60/424,262 filed Nov. 6, 2002; 60/546,241 filed Feb. 20, 2004; and Ser. No. 10/353,650 filed Jan. 29, 2003, all co-owned with the present invention, all fully incorporated herein for all purposes, and with respect to all of which the present invention claims priority under the Patent Laws.

### BACKGROUND OF THE INVENTION

1. Field of the Invention

The present invention is directed to choke systems for oil rigs and, in one particular aspect, to diagnostic/control systems for such choke systems.

2. Description of Related Art

In the drilling of oil wells a drill pipe is introduced into the wellbore with a bit on the lower end thereof and, as the bit is rotated, to circulate a drilling fluid, drilling “mud”, down through the interior of the drill string, out through the bit, and up the annulus of the well bore to the surface. Fluid circulation removes cuttings from the wellbore, cools the bit, and maintains hydrostatic pressure in the well bore to control formation gases and prevent blowouts, and the like. Additional backpressure is applied on the drilling fluid at the surface when the weight of the drilling fluid is not sufficient to contain the bottom hole pressure in the well to keep the well under control. In some instances, a backpressure control device is mounted in a return flow line for the drilling fluid.

Backpressure control devices or “chokes” are also used for controlling “kicks” in the system caused by the intrusion of salt water, oil, or formation gases into the drilling fluid, which may lead to a blowout condition. In these situations, sufficient additional backpressure must be imposed on the drilling fluid such that the formation fluid is contained and the well controlled until heavier fluid or mud can be circulated down the drill string and up the annulus to kill the well. It is also desirable to avoid the creation of excessive back pressures which could cause a drill string to stick, or cause damage to the formation, the well casing, or the well head equipment.

Maintenance of an optimum backpressure on the drilling fluid can be complicated by variations in certain characteristics of the drilling fluid as it passes through the backpressure control device. For example, the density of the fluid can be altered by the introduction of debris or formation gases, and/or the temperature and volume of the fluid entering the control device can change. Therefore, the desired backpressure is not achieved until appropriate changes have been made in the throttling of the drilling fluid in response to these changed conditions. Conventional devices generally require manual control of and adjustments to a choking device orifice to maintain the desired backpressure. However, manual control of the throttling device or choke involves a lag time and generally is inexact.

U.S. Pat. No. 4,355,784 discloses an apparatus and method for controlling backpressure of drilling fluid in the above environment in a system in which a balanced choke device moves in a housing to control the flow and the backpressure of the drilling fluid. One end of the choke device is exposed to the pressure of the drilling fluid and its other end is exposed to the pressure of a control fluid.

Conventional choke control systems can be difficult to utilize accurately or efficiently and can require a great deal of experience to operate properly. Some typical conventional choke control mechanisms have a needle valve to control the rate of hydraulic fluid flow and a direction lever for controlling the direction of an open/close valve in a choke device. For example, to make an adjustment to slowly increase the backpressure, an operator shuts down the needle valve supplying hydraulic fluid to a hydraulically actuated choke to reduce supply of hydraulic fluid to a minimum so that the choke element moves slowly in the direction selected by the open/close valve. The operator relies on his experience in interpreting the familiar sounds and physical feedback associated with manipulating the choke controls and physical feedback during choke manipulation. Resistance and vibration of a joystick and the sound of the air-over-hydraulic pump kicking can indicate to the operator that the choke control is engaged and operating. The operator looks at the backpressure and determines if a new desired backpressure was achieved. If the operator has missed a pressure target, another adjustment is needed using the open/close valve and the needle valve to adjust the choke until the desired backpressure is achieved. Proper adjustment of the choke element to achieve desired backpressure level can be an iterative procedure requiring multiple attempts. This is a time consuming, inefficient and relatively inaccurate procedure for adjusting a choke.

Prior art oil recovery systems have a vast network of various and assorted oilrigs platforms which can be widespread geographically. It is expensive to physically patrol, inspect and diagnose equipment failures, and to attempt to perform operational optimization in a fleet of hundreds or even thousands of oilrigs comprising a regional or global oil recovery system. There is a need for a remote monitoring and diagnostic and notification service for a wide area oil recovery system and a need for an automated process running on a plurality of oilrigs comprising an oil recovery system that performs a Health Check monitoring function of an oil recovery system.

### SUMMARY OF THE PRESENT INVENTION

The present invention, in certain embodiments, discloses a system for determining the operational state of a choke control system and an associated choke mechanism. Such a system, in certain aspects, determines the existence of an appropriate operational state for testing and diagnostics, e.g. a state in which operation of the choke control system is not imminent. In certain aspects, such a system according to the present invention performs periodic ad hoc choke system diagnostics, tests, and checks on a permission basis; and, in certain embodiments a secondary level test on the choke system determines when a primary level diagnostic, test or check can be run to verify the operational integrity of the electronic choke system. In certain embodiments, such periodic and ad hoc intelligent diagnostics, tests, and checks insure that the choke system is fully operational and completion of such diagnostics, tests, and checks provides a high degree of confidence that the choke system will work properly when called upon, e.g. on demand or in an emergency scenario. Choke systems according to the present invention may have one choke mechanism or a plurality of choke mechanisms, one of which is operational while at least one other choke of the plurality is in standby mode and can be diagnosed, tested, and exercised (e.g., selectively periodically operated).

In certain aspects, systems according to the present invention verify that required choke monitoring and control sensors are operational and that the choke mechanism works as intended. Degradation and failure rate data are recorded and stored in appropriate recording and storage devices, e.g. computers, so that degradation data can be correlated with failure data to predict failures from degradation data before the failures occur. In one aspect the choke system tests, checks, and diagnostic reports generated by a system according to the present invention inform a user as to the choke system readiness. The reports and intelligent diagnostics can address a user's well-founded concern whether a long idle choke system will work when called upon, e.g. to handle a high pressure kick in a wellbore.

In certain embodiments, systems according to the present invention provide tests, checks, and intelligent diagnostics specific to choke operational scenarios which enhance oil rig safety and efficiency of oil field drilling operations, in certain particular aspects when applied to an electronic choke control system associated with drilling chokes to ensure continuous and proper choke system availability during downhole operations. In certain systems according to the present invention failures, performance degradation and/or predicted failures are reported to service personnel that perform additional diagnostics or dispatch field personnel to replace or repair the choke systems as necessary.

The present invention provides a method and apparatus for remotely monitoring, analyzing and affirmatively notifying appropriate personnel of problems and events associated with an oil recovery system comprising hundreds of oil rigs over a vast geographic area. The present invention provides a monitoring and reporting system that is referred to as a Health Check system. The present invention provides a variety of performance monitoring sensors at each oilrig in an oil recovery system. The results of selected diagnostics, which are run on each oilrig, are reported to a central server. The central server automatically populates a database for the oil recovery system and displays a red/yellow/green/gray color-coded report for an entire oil recovery system. The present invention also affirmatively alerts appropriate personnel of actions required to address events associated with an oilrig in an oil recovery system. The diagnostics performed at each oilrig are configurable at the individual rig. The central server need not change its reporting and display program when changes are made to a heath check at an oilrig. The present invention provides a dynamic oilrig status reporting protocol that enables construction and display of a tree node structure representing an entire oil recovery system status on a single screen. Preferably, top level information is presented on a single screen, and detailed information presented when one drills down in to other screens. Thus, the present invention enables rapid visual affirmation of a system Health Check.

A Health Check is an automated test that is running on the rig and monitoring something for acceptable performance, indication of problems, etc. These tests could be applied to equipments, drilling processes, or an operator's usage of particular drilling equipment. The results are then communicated to a central server located in a service center through a unique protocol, which allows automatic distribution and display of information. A test program on a rig can be modified and that change will flow automatically through communication, storage and display of the resulting Health Check data for the rig.

The service center based web server allows secure access to Health Check results. The results are presented in “top down tree” mode with red/yellow/green/gray colors. The red color indicates the failure of a test or flagging an event of interest, the yellow color indicates that the health test has found some abnormality that may need attention, green indicates successful completion of a test, and gray color indicates inability to conduct a test. The bottom-most node of the “top down tree” contains the results of a Health Check. The work-case result is successively carried up to the next level, until topmost node (which in most cases is the drilling rig, group of rigs or oil recovery system) is reached.

Each Health Check result can be configured to generate a message (email, phone call, PDA, etc.) to alert single or multiple persons in case of test failure. The data transfer protocol is well defined, such that other development groups or third parties can easily develop Health Check tests, generate results and feed information to the central server. Test results are transferred from the rig to the server using a novel data protocol that dynamically defines the structure of the data, that is, the node tree structure of the data by the naming convention of the protocol. Thus, the results are simply stored and displayed using the structural definition provided in the communication protocol. This allows for extreme flexibility in the definition of new programs and results to run and report at oilrigs without requiring a change in the communication protocol, notification function or the display and storage functions at the central server. The bottom-most nodes in the tree structure contain test results. Each test comes into the central server as a record containing node information as to where the information fits within the tree structure, an identifier for the test, a test result (red/yellow/green/gray) and intermediate data such as error codes, operator entry data and test data description. Thus, no results processing need occur at the central server. The central server only archives and display results and issues affirmative (with acknowledgement) and regular notifications as required.

Events or conditions can be set for notification, thus, once the event or condition occurs and after it is set for notification, a notification is sent to a designated person reporting the event of condition. A list of persons can be associated with each oilrig and event or condition. A notification can be sent to a cell phone, PDA or other electronic device. A notification can comprise a text, audio or video message to a user. A notification tells the rig status color code, text, aural or video. A user can call into the central server to check the status of an oilrig or oil recovery system. The status returned is a notification message indicating that the rig is okay or that a problem or condition of interest has occurred. Thus, the Health Checks are different than alarms, although alarms (including those alarms generated by prior or legacy systems) can be used as inputs to a Health Check where the alarms are processed and considered by Health Check rather than sending an alarm immediately to oilrig personnel. Health Check may indicate that piece of equipment is out of range and should be replaced in the near future, however, supercritical alarms can be processed by Health Checks to generate an immediate notification.

What follows are some of, but not all, the objects of this invention. In addition to the specific objects stated below for at least certain preferred embodiments of the invention, other objects and purposes will be readily apparent to one of skill in this art who has the benefit of this invention's teachings and disclosures. It is, therefore, an object of at least certain preferred embodiments of the present invention to provide new, unique, useful, and nonobvious systems and methods of their use—all of which are not anticipated by, rendered obvious by, suggested by, or even implied by any of the prior art, either alone or in any possible legal combination.

Certain embodiments of this invention are not limited to any particular individual feature disclosed here, but include combinations of them distinguished from the prior art in their structures and functions. Additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods.

The present invention recognizes and addresses the previously-mentioned problems and long-felt needs and provides a solution to those problems and a satisfactory meeting of those needs. To one skilled in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

The Abstract that is part hereof is to enable the United States Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limited of the scope of the invention in any way.

### DESCRIPTION OF THE DRAWINGS

A more particular description of embodiments of the invention briefly summarized above may be had by references to the embodiments that are shown in the drawings which form a part of this specification. These drawings illustrate certain embodiments and are not to be used to improperly limit the scope of the invention that may have other equally effective or legally equivalent embodiments.

FIG. 1 is an illustration of a preferred status display for an oil recovery system showing status for individual rigs and aggregated worst-case status for geographical areas.

FIG. 2 is an illustration of a preferred status display for an oil recovery system showing status for individual rigs and aggregated worst-case status for a smaller geographical area including Western Canada.

FIG. 3 is an illustration of a preferred status display for an oil recovery system showing status for individual rigs and panel results showing text descriptions and color-coded status for a single oilrig.

FIG. 4A is an illustration of a preferred status display for an oil recovery system and a sub status for an individual rig.

FIG. 4B is an illustration of an alternative status display for an oil recovery system and a sub status for an individual rig.

FIG. 5 is an illustration of a preferred status display for an oil recovery system and a lower level sub status for an individual rig.

FIG. 6 is an illustration of a preferred status display for an oil recovery system and a lower level sub status for an individual rig.

FIG. 7 is an alternative tabular status display for an oil recovery system.

FIG. 8 is an alternative tabular status display for an oil recovery system.

FIG. 9 is an illustration of a preferred health check system reporting health checks from an oil rig to a user via satellite.

FIG. 10 is an illustration of a preferred health check system reporting health checks of multiple equipments, processes or systems from multiple oil rigs to a multiple users.

FIG. 11 is an illustration of a preferred protocol which defines an event reporting data structure for data base population and display.

FIG. 12 is an illustration of prior art choke control mechanism.

FIG. 13 is an illustration of a preferred embodiment of the improved choke mechanism operator interface.

FIG. 14 is an illustration of a preferred system showing the preferred operator interface and hydraulic-actuated choke control system.

FIG. 15 is an illustration of a preferred system showing the preferred operator interface and electric-actuated choke control system.

FIG. 16 is a flow chart illustrating the control steps taken by the present invention during a choke control operation.

FIG. 17 is an illustration of a control valve schematic with hydraulically-actuated chokes.

FIG. 18 is an illustration of the general components of the present invention.

FIG. 19 is an illustration of a touch screen display for a preferred embodiment of the present invention.

FIG. 20 is an illustration of a touch screen display for a preferred embodiment of the present invention.

FIG. 21 is an illustration of a choke control system associated with an oil rig.

FIG. 22 is a flow chart showing the process and apparatus for functions for running a diagnostic.

FIG. 23 is a flow chart showing the process and apparatus for functions for running a diagnostic.

FIG. 24 is a flow chart showing the process and apparatus for functions for determining if the standby mode is appropriate.

FIG. 25 is a flow chart showing the process and apparatus for functions for running a diagnostic.

FIG. 26 is a flow chart showing the process and apparatus for functions for running a diagnostic.

FIG. 27 is a flow chart showing the process and apparatus for functions for running a diagnostic.

FIG. 28 is an illustration of the choke control system, isolation valve and choke system.

FIG. 29 is a schematic view of a choke system according to the present invention.

### DESCRIPTION OF PREFERRED EMBODIMENTS AT THE TIME OF FILING FOR THIS PATENT

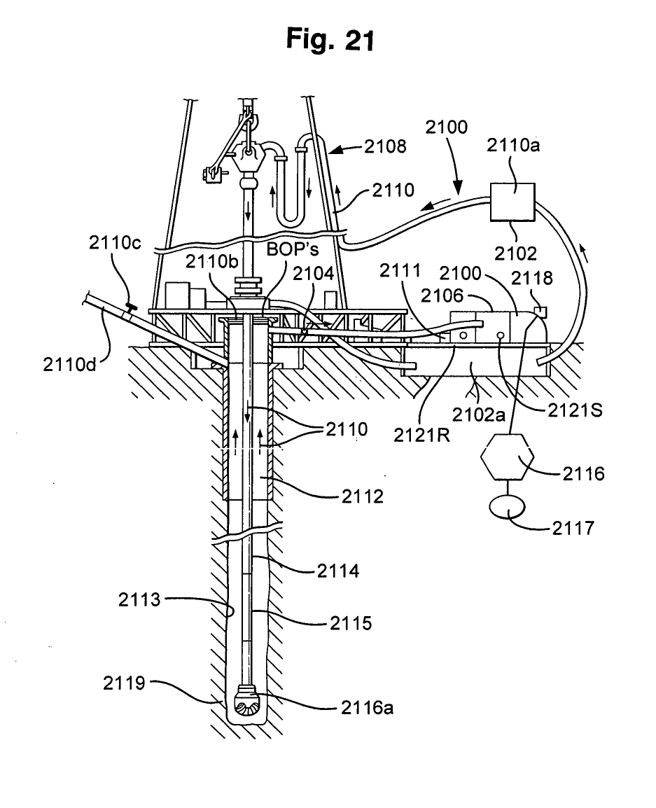

As shown in FIG. 21, a choke control system 2100 according to the present invention associated with drilling rig 2108 is shown schematically. A choke system 2106, isolation valve 2104 and mud supply system 2102 act together to regulate mud pressure as determined by a mud pressure measurement system 2111. Mud flow 2110 proceeds from the mud supply reservoir 2102a down a drillstring 2114 to a bottom hole assembly 2115 with a drill bit 2116 and returns up a wellbore annulus 2112 between a wellbore 2113 in earth 2119 and the drillstring 2114.

The choke control system 2100 operates in various “system control” modes or “system states.” The choke control system 2100 recognizes states of the system and commands the performance of intelligent choke mechanism diagnostics on the choke system 2106 appropriate to the system state. Control modes include: Local Control, Automatic Mode, Manual Override Mode, and Standby Mode. In the Local Control mode, the choke control system 2100 is under the command of a local user who directly controls the choke system 2106; or with a computer system 2116 e.g. any suitable programmable apparatus, apparatuses, system, systems, devices or device via a user interface, e.g., a panel system 2117. In the Automatic Mode, an Automatic Supervisory Control Function existing in a controller 2118 takes over the choke control system 2100. In the Automatic Supervisory Control Mode, operation of the choke control system 2100 is directed by an Automatic Control function in accordance with a data set of user-specified parameters (e.g. for using either a “drillers” method and “wait-and-weight” method). In the Manual Override Mode, the choke control system 2100 is under the control of a local or remote user who manually directs operation of the choke control system 2100. A kill line 2110d with a kill line valve 2110c serves as an emergency backup system and provides an alternate flow path for injecting fluids into the wellbore or for allowing wellbore fluids to flow out of the wellbore in a controlled manner. Blowout preventers 2110b provide blowout control.

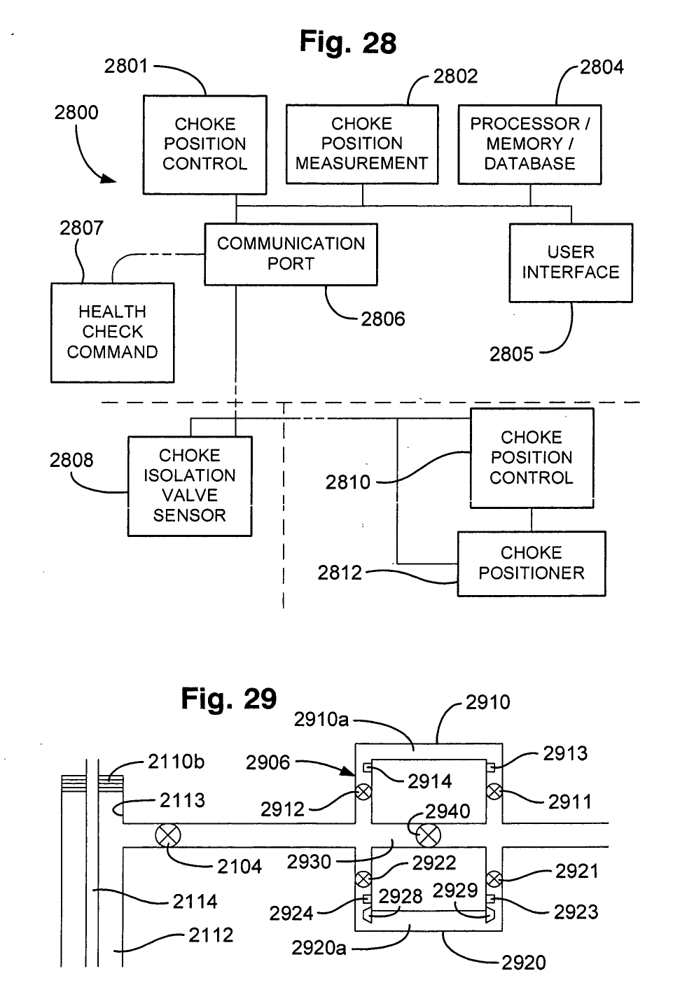

The Standby Mode allows initiation of tests, checks and diagnostics to determine the operational viability of the choke control system 2100. In standby mode, the choke isolation valve 2104 is closed to remove the choke system 2106 from the mud pressure line so that choke operation has no influence on the well pressure. The computer system 2116 determines when the choke control system 2100 is in standby mode (or a user can put in standby mode) and whether it is appropriate to stay in standby mode based on system conditions (system conditions e.g. from sensors, gauges, systems indicating, e.g. the position of valves, the status of BOP's, the annular pressure, the drill pipe pressure, and/or pump rate). The computer system 2116 also determines when the system can enter standby mode and who can command entry into standby mode. In the standby mode, the system can perform intelligent diagnostics; e.g. determining the state of choke control system sensors 2121 in communication with the control system and/or computer system, (sensors 2121R—choke isolation valve, sensor; 2121S—choke position sensor, e.g. the sensors 2808, 2810, FIG. 28) associated with the choke system 2106 and position control thereof. Determination of the active system control state (Local, Manual, Automatic or Standby) and the operability of choke and other system sensors is a primary diagnostic. Primary diagnostics are run before performing a secondary diagnostic. Secondary diagnostics include manipulation and monitoring of the choke control mechanism, such as, positional command performance. Secondary diagnostics are performed after information obtained during a primary diagnostic indicates that manipulation and monitoring of the choke control system 2100 is appropriate; e.g. when the choke control mechanism sensors are functional, the choke control mechanism is in the standby mode, and the system state for the rig 2108 is such that the choke system 2106 will not be needed for a period of time sufficient to perform the intelligent diagnostics currently intended. It is appropriate to stay in the standby mode and run a choke secondary diagnostic since the choke system 2106 is not needed at this time or in the immediate future. The standby modes can be entered only when the choke control system 2100 is not in a pressure control service mode. The system cannot go into standby mode if the detected annulus pressure is greater than zero; nor can it go into standby mode if the BOP's are closed.

Diagnostics for the choke system 2106, such as positional cycling, mechanism movement rate and positional feedback and monitoring, are performed during standby mode. These intelligent diagnostics enable a user or processor to determine whether the choke is operational or whether a failure has or will soon occur. The positional diagnostics move the mechanism of the choke system 2106 back and forth. This movement prevents the choke system 2106 from remaining idle and motionless for the extended periods of time. The positional and/or periodic cycling and/or operation of the choke system 2106 occurs when the choke is under electronic control (by the system 2100).

The choke system specific diagnostics include a scheduled performance including checks, tests, and intelligent diagnostics. These checks, tests and intelligent diagnostics evaluate all aspects of choke control system operation. In one example of a secondary choke control system diagnostic, the choke mechanism speed, direction, and positional accuracy are tested to determine the state and operational viability of the choke control system 2100. The performance of choke mechanism movement is monitored and evaluated. If the results of the choke control mechanism diagnostic are unacceptable or return suspect results, the choke control system 2100 conducts more detailed evaluation including additional checks, tests, and diagnostics to provide further insight into problem. The results of each diagnostic are stored in memory database and compared to a stored historical database for previous diagnostic results (e.g. stored in a database 2804, FIG. 28). These checks, tests and intelligent diagnostics inform a supervisory health check system (e.g. any according to the present invention as described herein) of the choke control system status. The user can select a “user-active” control mode, for example, the local, automatic or manual override mode where the choke is to be used. If the electronic choke system is not in green status according to the health check system, entry into the mode will be prevented or at least subject to a warning that the choke system is not in a reliable operating state. When the choke is in a standby mode, but when conditions dictate that the choke should be used or may be used immediately, a message issues to the choke operator to exit the standby state. Alternatively, the choke control system 2100 automatically exits the standby mode under these conditions, actuating the choke isolation valve 2104 and placing the choke system 2106 in automatic mode to handle risen or anticipated surges in well or casing pressure.

The choke system 2106 can be exercised and monitored to ensure that it is operational. For example, in one choke control diagnostic, the system commands the choke mechanism to move in small, medium, and/or large increments. The choke control mechanism is tracked and the resultant positioning accuracy and speed are evaluated. The choke control mechanism diagnostic moves the choke mechanism through its full travel distance and compares travel endpoint position feedback values. This test ensures that the choke system 2106 is operational and in good working order.

A significant advantage of the present invention is that the mechanism of the choke system 2106 is moved periodically (e.g. every 12 hours) so that it is not left idle for long periods of time or left in a fully closed position for extended periods. When the choke mechanism of the system 2106 is left idle or closed for a long period of time, adjacent choke mechanism elements or element seals, which are pressed together when the choke mechanism is closed, can bond closed as the choke mechanism elements may stick together. Upon opening, stuck choke mechanism seals may pull apart and be destroyed preventing the mechanism of the choke system 2106 from operating properly. Moreover, after the mechanism has been sitting idle for an extended period, its components may become stuck together preventing it from opening and make proper operation impossible. The seals on each end of a choke mechanism can also stick to each other so that they are pulled apart when the choke is operated. This periodic manipulation also prevents the user from leaving the choke mechanism closed or static in one position for extended periods of time, thereby destroying the choke mechanism operability and the necessity for an otherwise unnecessary service call to repair the damage.

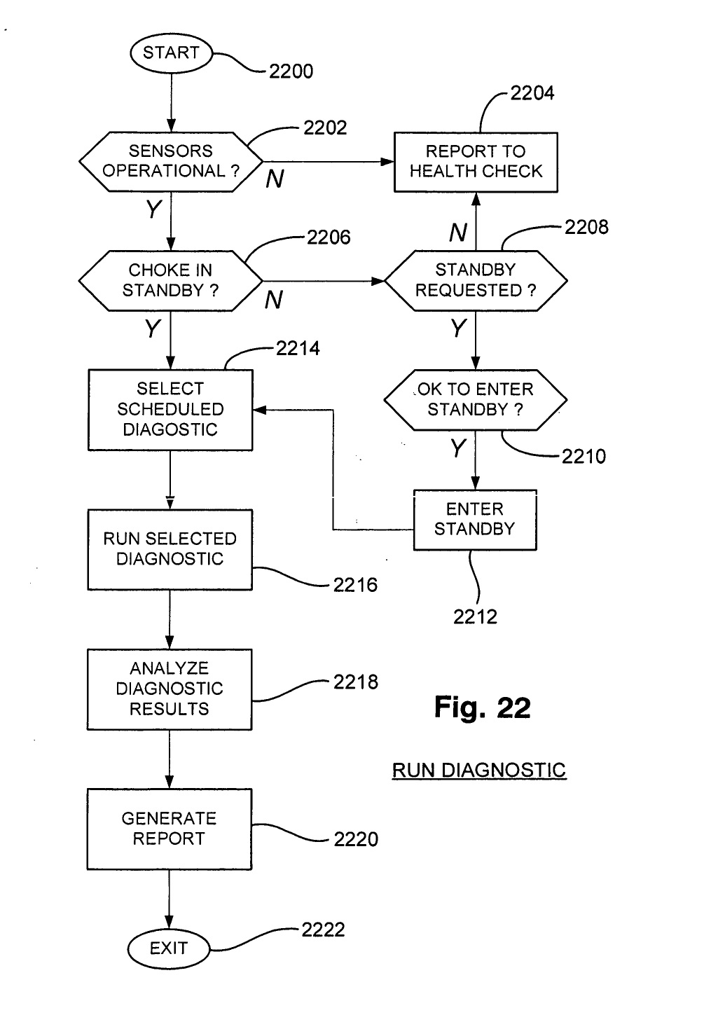

FIG. 22 shows a flow chart of process and functional events performed by the system 2100 and computer system 2116 during a “Run Diagnostic” event. At step 2200 the functional event is started (“START”). In step 2202 (“SENSORS OPERATIONAL”) the system determines if the choke sensors 2810 and 2802 (see FIG. 28), isolation valve sensors 2808 (see FIG. 28), and mud pressure measurement cell sensors 2121 are operational. If any one of the sensors is not operational, a report is sent to the health check processor in a step 2204 and a determination is made as to whether or not to continue to run the diagnostic event.

The next function 2206 (“CHOKE IN STANDBY”) determines if the choke is in standby mode. If the choke is in standby mode, the event proceeds to function 2214 (“SELECT SCHEDULED DIAGNOSTIC”) where a diagnostic is selected from a list of diagnostics in a database of the processor 2804 (see FIG. 28). Diagnostics may be scheduled or simply performed in order from the database. The parameters for the diagnostics are downloaded from the health checks. A schedule and order of execution for the diagnostics can be downloaded via communication port 2806 (see FIG. 28) from the health check system to a database of the processor 2804 or simply stored therein.

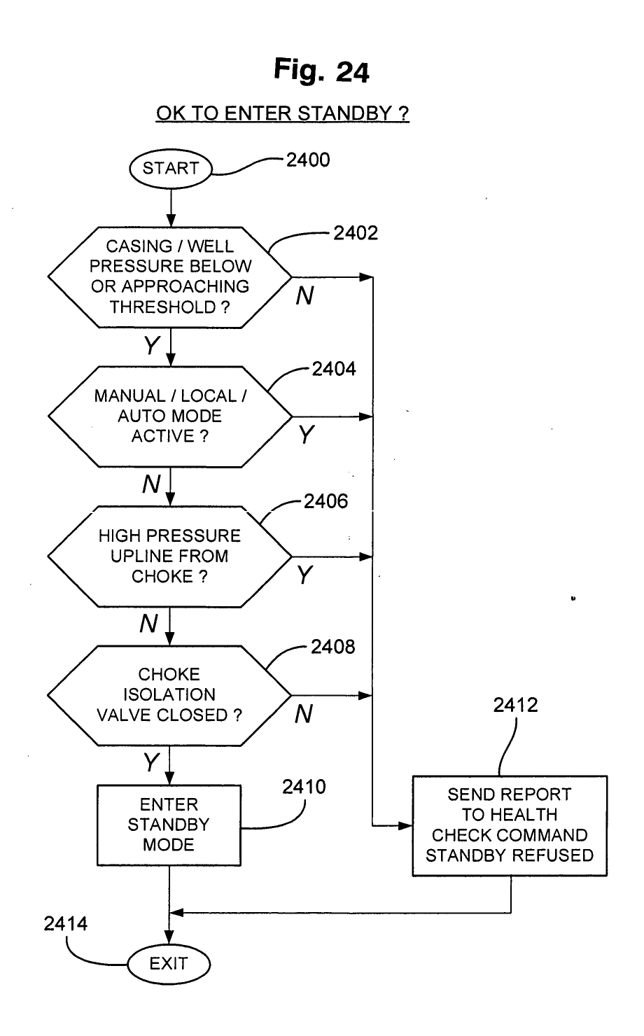

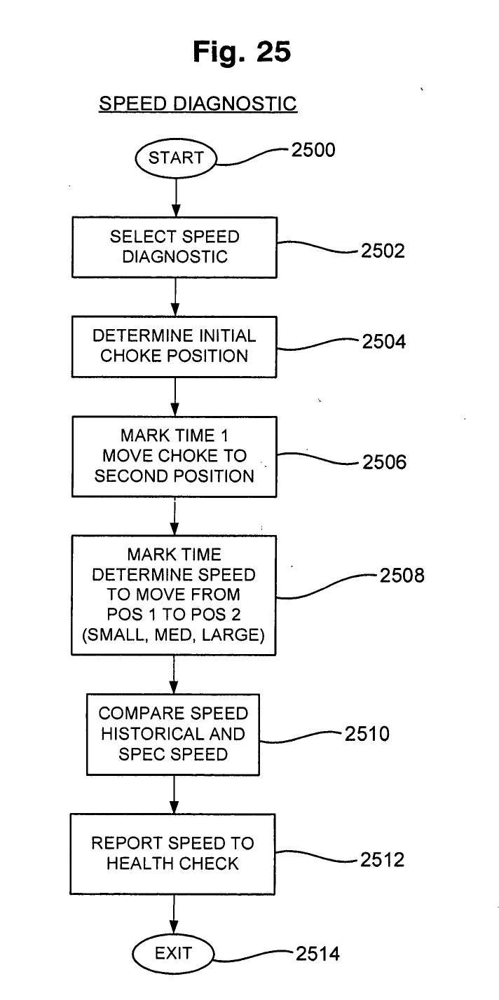

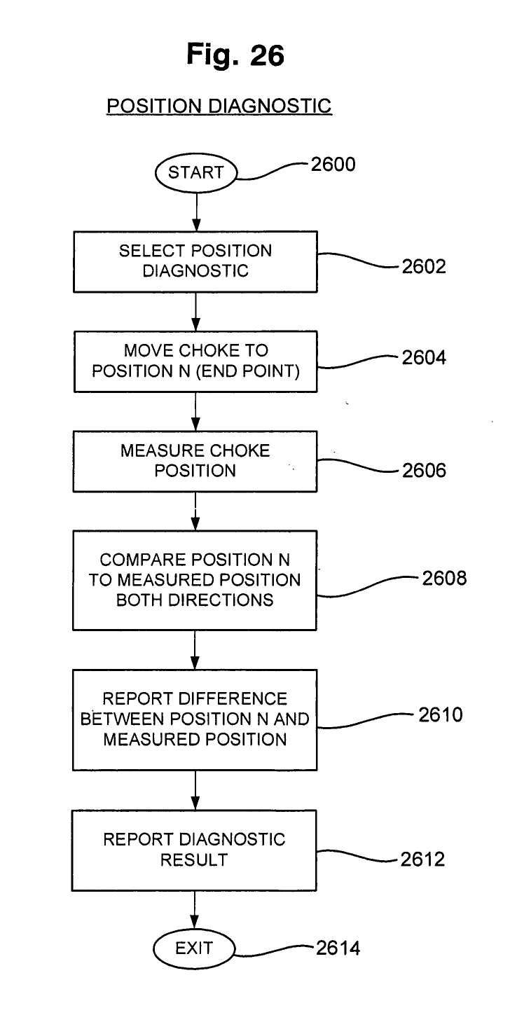

If the system is not in standby mode at step 2206, then it is determined if Standby Mode has been requested at 2208 (“STANDBY REQUESTED”). If Standby Mode has not been requested, as determined in step 2208 then a report 2204 (“REPORT TO HEALTH CHECK”) is sent to the health check commander. If Standby Mode has been requested, then the event proceeds to step 2210 (“OK TO ENTER STANDBY”) to determine if it is appropriate to enter into Standby Mode. This process of determining whether it is appropriate to enter standby mode is detailed further in FIG. 24. If it is appropriate to enter standby mode, the system proceeds to step 2214 and a scheduled diagnostic is selected. The selected diagnostic is then performed in step 2216 (“RUN SELECTED DIAGNOSTIC”). The functions performed for two exemplary diagnostics are shown in FIGS. 25 and 26.

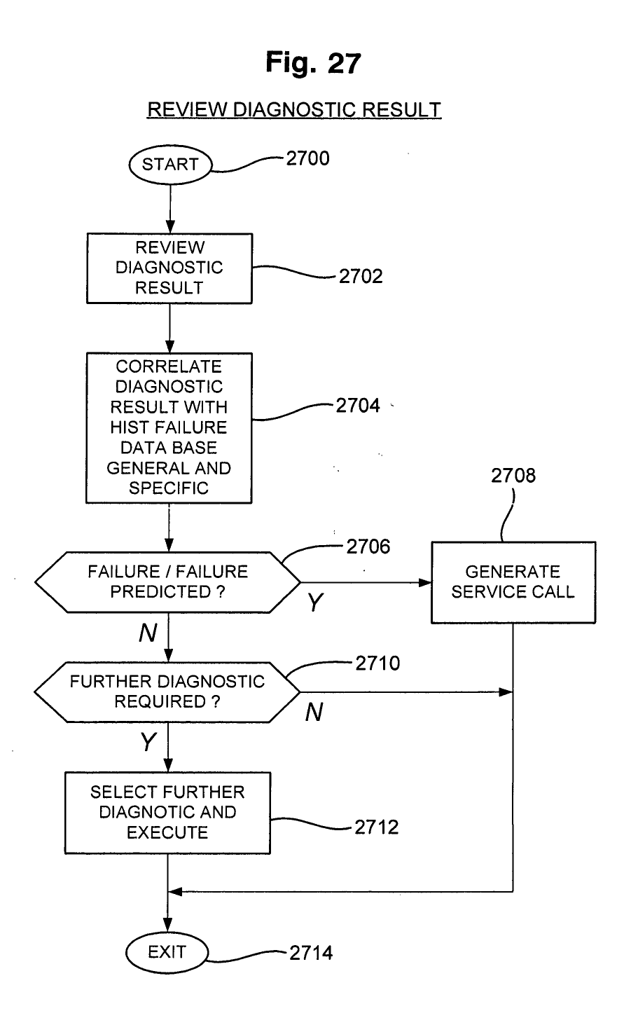

Upon completion of the selected diagnostic, the results are analyzed in step 2218 (“ANALYZE DIAGNOSTIC RESULTS”) and a report is generated in step 2220 (“GENERATE REPORT”). The Run Diagnostic is exited in step 2222. The analysis of the diagnostic result is detailed more fully in FIG. 27.

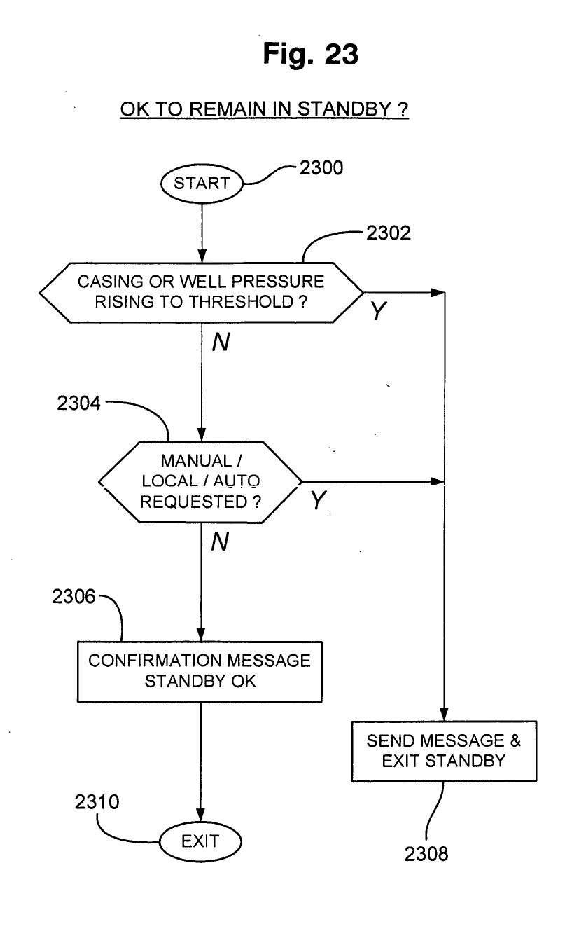

FIG. 23 shows the process and functions executed for the step “OK TO REMAIN IN STANDBY”, which determines whether it is appropriate to remain in Standby Mode. The event starts at an entry point 2300 (“START”) and proceeds to a step 2302 (“CASING OR WELL PRESSURE RISING TO THRESHOLD”) in which the system according to the present invention determines whether the casing pressure or well pressure has risen above a predetermined pressure threshold or is rising at or is approaching a predetermined pressure threshold. The predetermined threshold is stored in a database of the processor 2804. The predetermined threshold, for example 20,000 pounds per square inch, is compared to the pressure as measured by the mud pressure measurement system 2111. If the casing or well pressure is too high or rising too quickly as determined in step 2302, then a message is sent to the operator and the standby mode is exited in step 2308. If the casing pressure and well pressure are sufficiently low as determined in the step 2302, then in a step 2304 (“MANUAL/LOCAL/AUTO REQUESTED”) it is determined whether a user active mode (Manual, Local or Automatic) has been entered. If a user active mode has been entered, then a message is sent to the operator and the standby mode is exited in the step 2308. If a user active mode has not been entered, then a confirmation message that is appropriate to stay in standby mode is sent in step 2306 (“CONFIRMATION MESSAGE STANDBY OK”) and the function is concluded in a step 2310.

FIG. 24 illustrates a system determination of whether it is appropriate to enter the standby mode. The event starts at a step 2400 (“START”) and proceeds to a step 2402 (“CASING/WELL PRESSURE BELOW OR APPROACHING THRESHHOLD?”) in which it is determined whether the casing and well pressure are below a predetermined threshold stored in a database of the processor 2804. If the casing and well pressure are not below a predetermined threshold, the report is sent in a step 2412 (“SEND REPORT TO HEALTH CHECK COMMAND STANDBY REFUSED”) to the health check command 2807 (see FIG. 28) that the Standby Mode is not appropriate and the request to enter the Standby Mode has been refused. In a step 2404 (“MANUAL/LOCAL AUTO MODE ACTIVE?”) the system checks to see if the Manual, Local or Automatic modes have been entered. If the Manual, Local or Automatic modes have been entered, a report is sent in a step 2412 to the health check command 2807 that the Standby Mode is not appropriate and the request to enter the Standby Mode has been refused. In a step 2406 (“HIGH PRESSURE UPLINE FROM CHOKE”) the system checks to see if the high pressure exists up line from the choke mechanism. If the high pressure exists up line from the choke mechanism a report is sent in a step 2412 to the health check command 2807 that the Standby Mode is not appropriate and the request to enter the Standby Mode has been refused. In a step 2408 (“CHOKE ISOLATION VALVE CLOSED”), the system checks to see if the choke isolation valve 2104 is closed. If the choke isolation valve 2104 is not closed, a report is sent in a step 2412 to the health check command 2807 that the Standby Mode is not appropriate and the request to enter the Standby Mode has been refused. If steps 2402, 2404, 2406 and 2408 are accomplished, then in a step 2410 the standby mode is entered (“ENTER STANDBY MODE”) and the function is concluded in a step 2414.

FIG. 25 illustrates the functions and process for a “SPEED DIAGNOSTIC” done with a system according to the present invention. Following system start (step 2500, “START”) a particular speed diagnostic is selected in a step 2502 (“SELECT SPEED DIAGNOSTIC”) (e.g. selection of a desired exercise which has a known desired speed; selection of slow, medium, or fast speed; selection to open or close a valve or mechanism). The initial choke position is determined by monitoring the choke position sensor in a step 2504 (“DETERMINE INITIAL CHOKE POSITION”). Any offsets determined by positional performance diagnostics (see FIG. 26) are added or subtracted as appropriate to adjust the choke mechanism position as sensed. In a step 2506 (“MARK TIME 1 MOVE CHOKE TO SECOND POS”) the time is marked or recorded by the processor 2804 and the choke mechanism is commanded to reposition to a second position. In a step 2508 [“MARK TIME DETERMINE SPEED TO MOVE FROM POS 1 TO POS 2 (SMALL, MED, LARGE)”] the time at which the choke mechanism reaches a position 2 is recorded. A speed is calculated from the distance between a position 1 and the position 2 divided by the time required to move from the position 1 to the position 2. Speed is measured for small, medium and large distances. Small, medium and large distances are approximately 10%, 50% and 100%, respectively, of the available travel of the choke mechanism. In a step 2510 (“COMPARE SPEED HISTORICAL AND SPEC SPEED”), the speed is compared to prior historical speed measurements and to a specification speed stored in a database 2804 (see FIG. 28). The speed is reported to the health check process in a step 2512 and the diagnostic is concluded (“EXIT”) in a step 2514.

As shown in FIG. 26, a system according to the present invention can determine the position of the choke, starting in an entry step 2600 (“START”) and proceeding to a step 2602 (“SELECT POSITION DIAGNOSTIC”) in which the position diagnostic is chosen (e.g. to instruct the choke mechanism to go to a full open, full closed or ½ way position). In a step 2604 [“MOVE CHOKE TO POSITION N (END POINT)] a choke positioner 2812 (see FIG. 28) is commanded to move the choke mechanism to a first position N, preferably an end point of travel for the choke mechanism. In a step 2606 (“MEASURE CHOKE POSITION”) the choke position sensor 2810 (see FIG. 28) is read to determine the measured position M. The measured position M is compared to the position N to which the choke was commanded to move in the step 2604. The difference between position M and position N is calculated by the processor to determine the difference between the actual position measured and the desired position commanded [in a step 2608 (“COMPARE POSITION N TO MEASURED POSITION BOTH DIRECTIONS”)]. In a step 2610 (“REPORT DIFFERENCE BETWEEN POSITION N AND MEASURED POSITION”) this difference between position M and position N is reported to the health check command 2807 and the processor 2804. This difference is reported in a diagnostic results step 2612 (“REPORT DIAGNOSTIC RESULT”) and the function is exited in a step 2614. The diagnostic result, like all other diagnostic results, is analyzed by a “Review Diagnostic” result program (see FIG. 27).

The process and functions for reviewing system diagnostic results is illustrated in FIG. 27 starting with a step 2700 (“START”) and proceeding to a step 2702 (“REVIEW DIAGNOSTIC RESULT”) in which a diagnostic result is reviewed. In a step 2704 (“CORRELATE DIAGNOSTIC RESULT WITH HIST FAILURE DATABASE GENERAL AND SPECIFIC”) the diagnostic result is correlated with the historical failure rate associated with the current diagnostic result. The historical failure rate is based on diagnostic data for the specific choke being analyzed as well as the general trend for chokes of the same manufacturer and chokes in general based on the trend established by the series of measurements and diagnostic data reported. The trends and correlative data are stored in memory of the processor 2804. Based on the correlative data and the diagnostic reports the system detects a failure; or, based on data or a data trend, determines that a failure is imminent or predicted (in a step 2706, “FAILURE/FAILURE PREDICTED”) and generates a repair service call in a step 2708 (“GENERATE SERVICE CALL”). If a failure is not predicted, a further diagnostic may be required, which is decided in a step 2710 (“FURTHER DIAGNOSTIC REQUIRED”). If an additional diagnostic is required, the additional diagnostic is selected in a step 2712 (“SELECT FURTHER DIAGNOSTIC AND EXECUTE”) and executed similar to the diagnostics shown in FIGS. 25, 26. The function is concluded in a step 2714.

In an embodiment 2800 shown in FIG. 28 a choke positioner 2812, a choke isolation valve sensor 2808, and a choke position sensor 2810 are shown (as can be used with the system of FIG. 21). Also shown is the health check commander/process and health check system (“HEALTH CHECK COMMAND” 2807) as described in the co-pending co-owned U.S. patent application Ser. No. 10/373,216 discussed above along with the electronic choke as described in the co-pending co-owned U.S. patent application Ser. No. 10/353,600 as described above in the Related Applications section. Also shown is a choke position controller 2801; a choke position measurement function 2802; the processor and memory/database 2804; a user interface 2805; a communication port 2806 (which communicates with the health check system, the choke control system, and/or the choke isolation valve sensor); the choke position sensor 2810; and the choke positioner 2812. The choke system itself is below the horizontal dotted line in FIG. 28.

FIG. 29 illustrates schematically a choke system 2906 according to the present invention which may be used in the system of FIG. 21 as the choke system 2106, e.g. for controlling flow and/or in diagnosing, testing, and/or checking a choke in standby mode. The blowout preventers 2110b and the isolation valve 2104 are the same in both systems. According to the present invention the choke system 2106 can be a multi-choke system with a plurality of two, three, four or more chokes manifolded for use with a drilling system. The choke system 2906 as shown in FIG. 29 has two choke systems 2910 and 2920. The choke system 2910 includes a line 2910a for mud flow with valves 2911, 2912 for selectively controlling flow in the line 2910a. The choke system 2920 includes a line 2920a for mud flow with valves 2921, 2922 for selectively controlling flow in the line 2920a. Sensors 2913, 2914, 2923, and 2924 (like the sensors 2121) provide the information to the choke control system and/or computer system. A valve 2940 selectively controls flow in the line 2930.

Either choke system 2910 or 2920 can be used. When one system is in use, one choke system can be in standby mode while mud is flowing through the line 2930 and/or through the other choke system. The choke system in standby mode can be diagnosed, analyzed, and checked (e.g. as is done for the choke system 2106, e.g. as described for FIGS. 21-28). For example, with valves 2104, 2911, and 2912 open and valves 2921, 2922, and 2940 closed, the choke system 2920 can be maintained in standby mode and the variety of diagnostic steps and checks disclosed herein may be performed for the choke system 2920. Optionally, pressure sensors 2928, 2929 (or one of them) in communication with the control system and/or computer system confirms isolation of the choke system 2920.

While a hydraulic-actuated choke has been used for example purposes above, the present invention principles apply to any choke with any type of actuation. As noted above, the present invention confirms (by evaluation of the state of the choke mechanism control, the hydraulic control valve and other related choke sensors) that it is safe to enter into the standby mode. Unless that confirmation is present, the choke system should not enter into standby mode. This confirmation can be determined from the status of the choke and kill line valves (e.g. the valves 2104 and 2110c in FIG. 21), e.g. confirmation is that both valves are closed and proper pressure isolation is provided. If the kill line valve is open, the system cannot go into standby mode; e.g. in the system of FIG. 21 both valves 2110c and 2104 must be closed to go into standby mode.

In another embodiment, the present invention (and any and all steps and/or events described above for FIGS. 21-28) is implemented as a set of instructions on a computer readable medium, comprising ROM, RAM, CD ROM, Flash or any other computer readable medium, now known or unknown, that when executed cause a computer or similar system to implement the method and/or step(s) and/or events of systems and methods according to the present invention.

The present invention is described herein by the following example for use on drilling rigs, however, numerous other applications are intended as appropriate for use in association with the present invention. In a preferred embodiment the present invention replaces conventional choke control methods and apparatuses with an improved digital choke control system that provides a more accurate and faster response choke control than prior systems while maintaining the look and feel of prior known choke control systems. The user adapts to perceive the present invention as the preferred manner of controlling the choke versus known conventional choke control methodologies and apparatuses. The present invention also enables direct control of both pressure and position associated with a choke.

The present invention is a replacement for any application requiring the use of a choke (e.g., but not limited to chokes used in wellbore operations, e.g., but not limited to drilling, unloading, flow testing, pressure testing, fluid changeovers such as in cementing and completion operations). Preferably the user relies on the conventional known choke control methods only as emergency manual backup stations used to back up the improved choke control method and apparatus provided by the present invention. It is expected that the user population will eventually develop enough familiarity and confidence in the choke controlling method and apparatus of the present invention that the user interface provided by the present invention will become the only choke-control-related component located on the rig floor. Eventually, it is expected that in order to simplify rig operations and create more space on the rig floor, that users will exclusively utilize the present invention to the exclusion of conventional choke control methodologies and configure rigs without conventional choke control equipment on the rig floor. That is, all conventional choke control equipment (such as choke console for hydraulic actuators, remote manual station for electric actuators, etc) will be either removed or initially omitted from a rig floor configuration design. It is expected that the drilling industry will eventually gravitate to the exclusive use of method and apparatus of the present invention as the only choke control function on the rig floor.

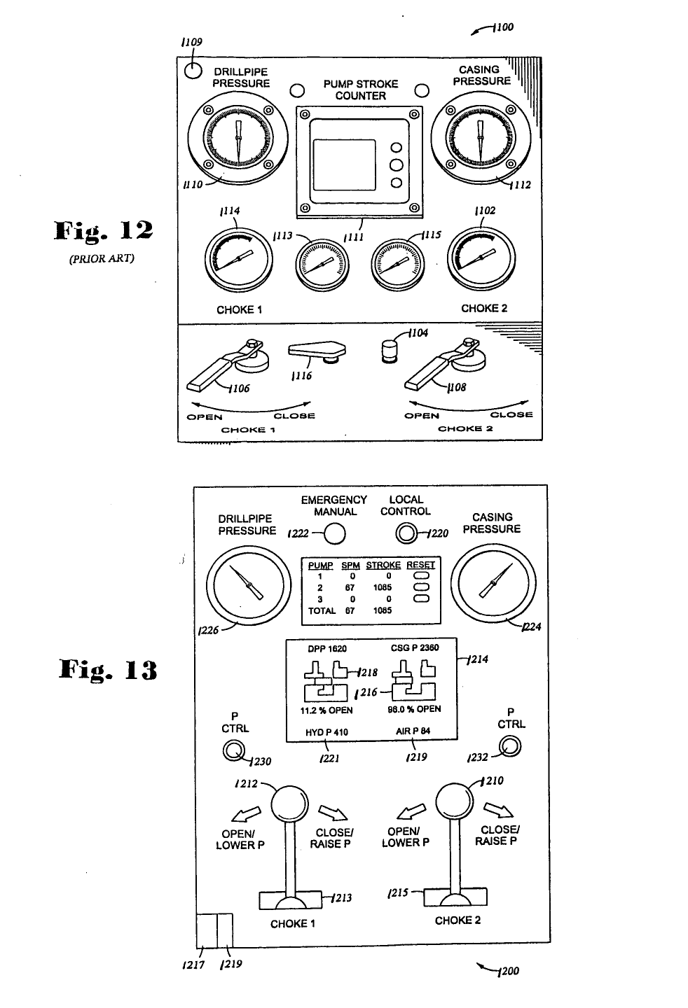

As shown in FIG. 12, conventional choke control mechanisms, known in the prior art comprise a console 1100 and direction controls 1106 and 1108 for choke 1 and choke 2 respectively. Choke 1 has associated position readout dial 1114 and choke 2 has associated position readout dial 1102. The casing pressure is indicated by readout casing pressure gauge 1112. The drill pipe pressure is indicated by drill pipe pressure read out gauge 1110. Speed control is provided by needle valve 1104. A pump stroke counter is provided by a central display 1111. A control 1116 for air supply cut-off valve is on the console.

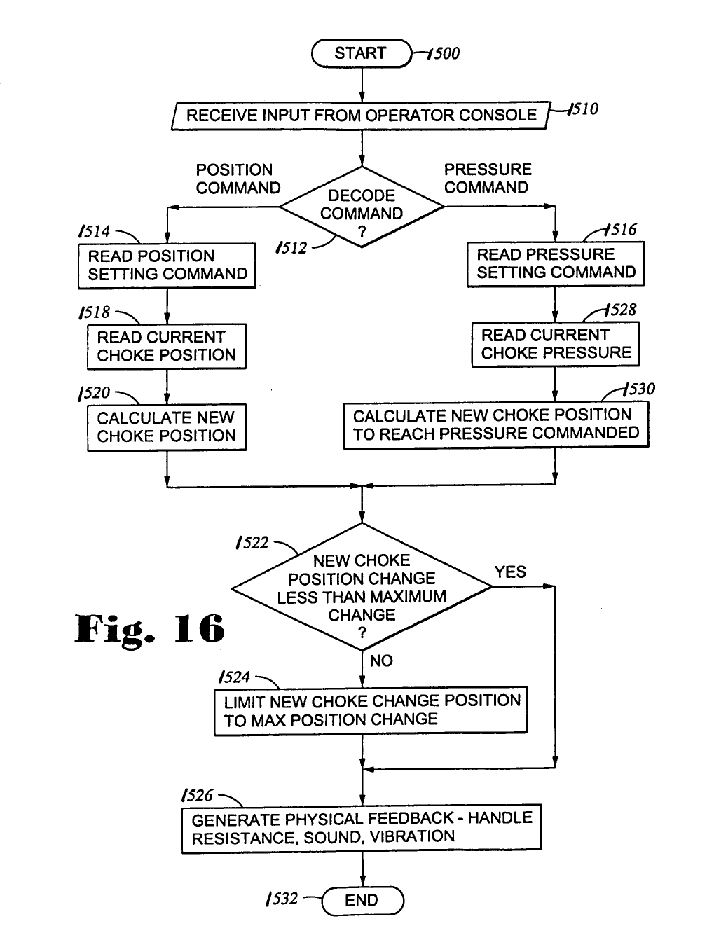

An improved choke control user interface according to the present invention is shown in FIG. 13. In general, the present invention controls both hydraulically and electrically actuated chokes. The control signals to the actuator may be open/close commands or position-set point commands or pressure set point commands, dependent on specific actuator capabilities and design decisions for the particular implementation or selection of features of the present invention. The preferred choke control operator station 1200 or interface comprises choke control joysticks 1212 and 1210 for directly controlling either the position or the pressure for choke 1 and choke 2 respectively. Data display 1214 generates operator visual feedback showing various instrument readings comprising a graphical display of choke 1 and its position 1218 and choke 2 and its position 1216. Casing pressure is shown in gauge 1224. Drill pipe pressure is shown in gauge 1226. Emergency Manual indicator 1222, for example, a red light indicates to the operator when the Emergency Manual backup system has taken over from the digital operator choke controller interface 1200. Local control light 1220 indicates when this choke control operator interface 1200 is in control and active in the choke control process. Multiple choke control operator stations 1200 may be provided on a single oil rig. Processor 1217 performs calculations shown in FIG. 16 and provides physical feedback via a sound generator 1219 and variable resistance to joy stick 1212 and 1210 via variable resistance mechanical interface 1213 and 1215 respectively. A display 1221 displays hydraulic pressure in the hydraulic pressure reservoir of the choke control system.

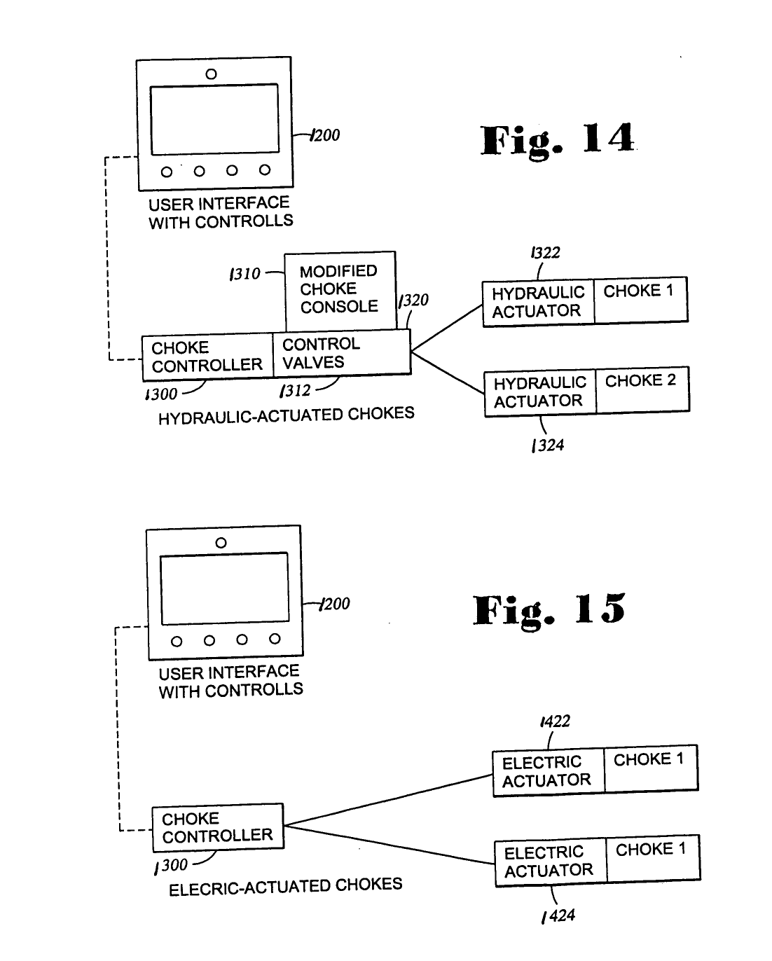

As shown in FIG. 14, the Digital Operator Control interface 1200 and Choke Control System 1300 of the present invention work together to control the choke. Choke Control System 1300 takes inputs from the Digital Operator Control interface 1200 and sends control commands to control valves 1312 in association with modified choke console 1310. The control valves module 1312 controls flow of hydraulic fluid to hydraulic actuator 1322 for choke 1 and hydraulic actuator 1324 for choke 2.

As shown in FIG. 15, the Digital Operator Control interface 1200 and Choke Control System 1300 of the present invention work together to control the choke. Choke Control System 1300 takes inputs from the Digital Operator Control interface 1200 and sends control commands to electric actuator 1422 for choke 1 and electric actuator 1424 for choke 2.

FIG. 16 illustrates a process flow chart for receiving inputs from an operator an controlling either the position or pressure directly, beginning with a “START” step 1500 and proceeding through steps 1510-1532.

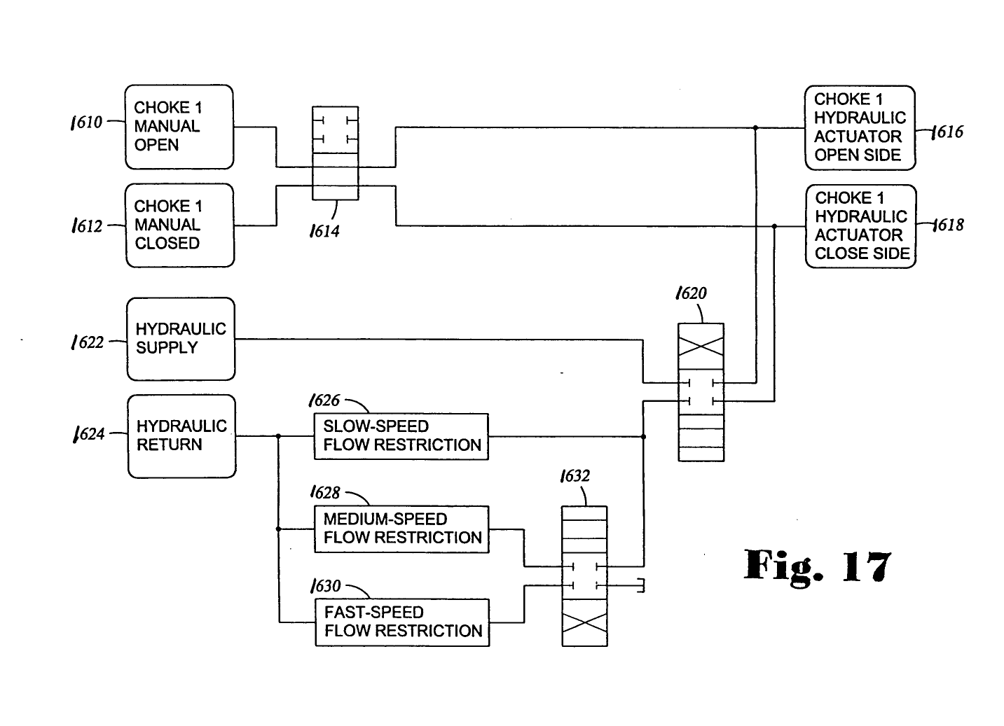

FIG. 17 illustrates a control valve schematic for hydraulically actuated chokes. Choke control emergency manual backup open 1610 and emergency manual backup close 1612 interface with control valve 1614 to operate choke hydraulic actuator open side 1616 and choke hydraulic actuator close side 1618. Hydraulic supply 1622 interfaces with directional control valve 1620 which controls flow of hydraulic fluid to operate choke hydraulic actuator open side 1616 and choke hydraulic actuator close side 1618. Hydraulic return 1624 interfaces with slow speed flow restriction 1626, medium speed flow restriction 1628 and fast speed flow restriction 1630. A valve 1632 interfaces with valve 1620 and, function restrictions 1626, 1628 and 1630 to provide speed control for choke movement.

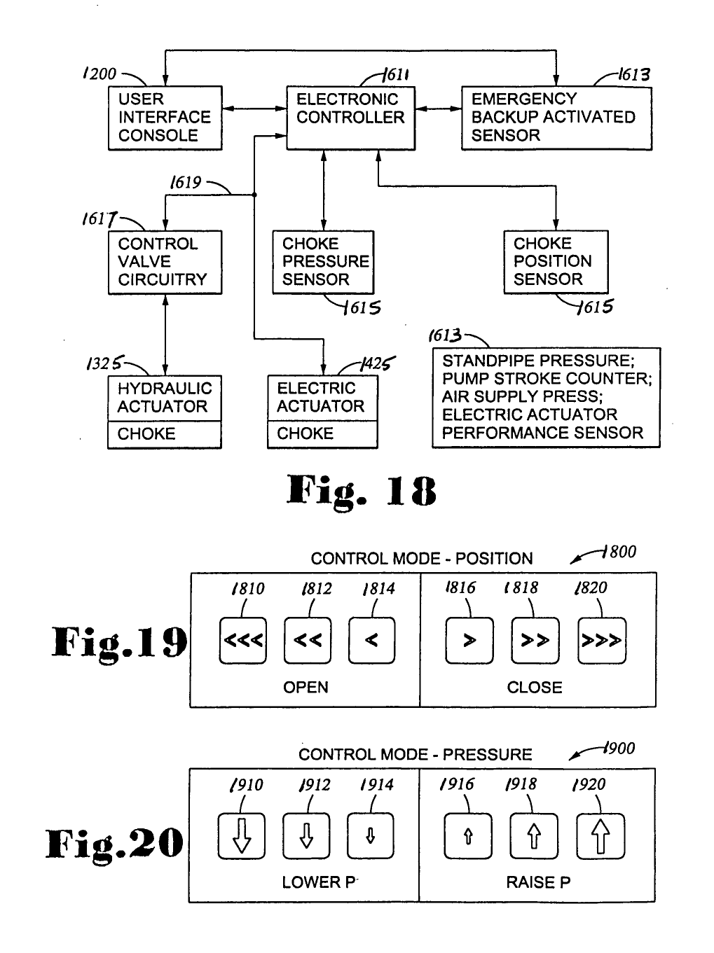

FIG. 18 is an illustration of the general components of the present invention. The general components of the present invention include a user interface 1200 (see FIG. 14), an electronic controller 1611, emergency backup activated sensor 1613, control valve circuitry 1617, hydraulic actuator 1325, electric actuator 1425, choke pressure sensor 1615, control output signals 1619, choke position sensor 1616, and sensors 1613 stand pipe pressure, pump stroke count, hydraulic supply pressure, air supply pressure and electric actuator performance. The control valve circuitry 1617 is provided to control hydraulic fluid flow to the actuator; thereby controlling the direction of flow (open/close routing) and rate of flow.

Examples of choke/actuator combinations supported by the present invention comprise: M/D Totco drilling choke with hydraulic actuator; Power drilling choke with worm-gear hydraulic actuator; and Chimo Willis choke with electric actuator, with either open/close or position-set point actuator controller (integral to actuator). The present invention is extendable to virtually any other choke/actuator combination.

The present invention provides for the control of a variety of remotely-actuated drilling chokes. The quality and presentation of the overall design is preferably consistent with different choke mechanisms and thus will not be intentionally reduced by the constraints of any specific actuator or choke as the control methods and apparatus provided by the present invention are independent of actuation methods and choke performance curves. Preferably a consistent user view is provided to maintain intuitive operation between configurations provided for the various choke mechanisms.

For hydraulic-actuated chokes, the present invention provides an interface with existing actuators and choke consoles, with following functions provided at the user's console: Quick-connects for pressurized hydraulic supply and return lines for quick retrofitting of the present invention into existing choke installations; Emergency Manual Backup button and a “Station in Control” indicator light. As discussed below, the operator interface comprises aural, visual and physical feedback to the user in a simulation of traditional choke control methodologies.

For electric-actuated chokes, the present invention provides an interface with the existing actuators and choke consoles, with following functions added to console: Interface and electrical devices as needed to interface with specific actuator comprising, for example, the Emergency Manual Backup functionality as implemented in present invention.

The base configuration for the preferred embodiment of the present invention comprises Dual chokes; Position- and pressure-set control; a “Full choke console” integrated display; and a User interface connected to controller with wires.

The initial list of configuration options for the present invention preferably comprises: Inclusion of each actuator/choke combination on the supported list; Single choke only; Position-set control only; Limited display; High-availability system; Additional user interface stations; Wireless user interface station and wireless controller. The present invention provides an emergency manual backup method and apparatus, which includes the traditional choke control methodologies with which the users are intuitively and extensively familiar. Thus, operator's wealth of experience and expertise are not diminished by introduction of a new product with which they have no experience and would have to traverse a possibly steep and costly learning curve. The present invention, in certain aspects, looks and feels and sounds like the conventional choke control device with which they are familiar. All currently known pressure control techniques are usable with present invention. The currently-known choke control methods are available for inclusion, if desired, as an emergency manual backup method and apparatus.

The activation of the emergency manual backup method of control will be initiated at the emergency manual control station located off the rig floor. When the emergency manual backup method is activated, notice of this activation becomes evident at the operators console 1200 via a perceptible aural, visual or physical operator notification signal at the console as part of the user interface for the present invention, such as 1222. When the emergency manual backup is activated, it takes over through the emergency manual backup user interface and the control functionality of the present invention user interface will be disabled.

In a preferred embodiment, a duplicate display is provided of the operator console lights on the rig floor choke control console 1220 and 1222 at the emergency manual back up console to inform the user via the emergency manual back up console user interface and show the activation state of the emergency manual backup on a separate display at the emergency manual backup station.

In one aspect of an arrangement for the present invention provides a user interface on the rig floor and all other components are located near the actual chokes. An alternative arrangement is provided to accommodate cases wherein a user customer prefers a different arrangement; e.g. at initial introduction or initial use of a system according to the present invention in critical well conditions.

The present invention is compatible with locating an alternate and already accepted control method on the rig floor. Typically, for hydraulic-actuated chokes this would be the choke console, and for electric-actuated chokes this would be a remote open/close control station.

All of the functionality of the present invention, except for the pressure-set control mode, is easily usable by any choke operator with previous experience on a conventional choke with the same type of actuation (e.g. hydraulic or electric). The pressure-set control mode functionality is easily usable by a similarly-experienced choke operator after a brief (i.e. less than 15 minutes) introductory training period, which might be a video, a rig-site simulator, a web-based introduction, exposure in a well control school, hands-on training by service personnel, etc.

The present invention provides physical user controls (such as joysticks, buttons, etc.) in all cases where there is extensive or high frequency use of the control. The simulation of the traditional choke control experience bolsters user confidence as it provides an experience close to, if not identical to, existing choke control methods. The emulation of traditional methods provided by certain systems according to the present invention enables experienced operators to operate the choke control method and apparatus of the present invention by feel, that is, without looking at the controls. In an alternative embodiment, other types of controls are provided, such as graphical touch screen controls and membrane-type buttons.

A neural network is provided and trained to learn the conventional choke control method and physical feedback associated therewith. The neural network can reproduce physical feedback given a set of operational parameters.

The present invention, in certain aspects, provides all user controls, regardless of type, designed for maximum usability. The control choices and how to execute them are evident and unambiguously clear. Conventional physical feedback is provided for all operator actions and system actions which enable presentation of an intelligible conceptual model with which the operator is familiar.

Both types of control functionality (i.e., position-set and pressure-set control) are provided to the user as discrete and as continuous actions. A discrete action is provided in response to a single crisp user action, for example, pressing a button or pressing and releasing a button or moving a joystick to a specific position. A continuous action is provided when a user maintains a control in one state, for example, holding a button down or maintaining a joystick within a specific position range. The continuous control action is carried out on a regular basis, which is managed by the user. Accelerating-type continuous control actions are not allowed by the present invention and are overridden by the processor. Both types of control actions are provided to the user in a three-value range (example—small/medium/large magnitudes of change).

The position-control functionality is provided to the user in the form of relative position movements in the open and closed directions. For example, the values offered may be 0.1%, 1% and 10% change in the position of the choke element inside of the choke. The new position set point is computed using the relative position increment and the current position. Thus, the position set point is not allowed to “race ahead” to values far from the current position.

The relative position increment is initially fixed for all chokes and actuators. The present invention enables tuning the relative position increment to the specific choke characteristics (loosely), the benefits of which would include increased operator convenience and improved control performance.

When the pressure control mode is selected, the pressure set point will be set to measured choke pressure. The user will be offered the opportunity to raise or lower the pressure set point by a selected pressure increment. For example, the range of pressure set point change values offered may be 25 psi, 100 psi and 500 psi. The new pressure set point is computed using the relative pressure increment and the current pressure. Thus, the pressure set point is not allowed to “race ahead” to values far from the current pressure.

In a preferred embodiment, the pressure set point value is visible to the user, however, knowledge of the pressure set point value is not in any way required to operate the pressure-set point control mode, just as a driver can operate a car with cruise control and never sees the speed set point value.

Any set of control set point incremental change values (whether position or pressure) offered to the user (i.e. the three-value ranges noted above) are limited to values which are within the measurable and controllable limits of the specific configuration of equipment of the present invention.

The present invention provides emulation-enhanced dual controls so that the user should be able to use the same control to operate with either control mode, and the operation of the control is consistent with the user's previous choke control experience. In one aspect, the experience of operating the controls associated with the choke element movement is consistent between both control modes. For example, closing the choke in position-set control mode and raising the pressure set point in pressure-set control require similar control actuation movements and produce a similar physical experience for the operator.

When the user is in a given control mode provided by the present invention, either position-set point or pressure-set point control mode, the control device provides the user suitable physical feedback so that he can continue to exercise control based on physical feedback without looking at the control device. The control device provides an emulation of the traditional choke control experience with sufficient tactile, aural, visual and/or physical feedback of sufficiently obvious orientation such that at any time the choke control operator can tell where the current control command is and how to select other commands based solely on the perceived feedback or feel from the emulation of the traditional choke control experience associated with the control device. In one aspect this experience is provided by a physical simulation or emulation of the conventional choke control experience, so that the controls look, sound and feel comfortable and familiar much like the conventional choke control experience. Simulating the conventional choke control experience enhances the safety of an operation while increasing an operator's ability to effectively operate the improved choke control method and apparatus of the present invention and avail himself of its benefits.

One embodiment of the present invention has sensors for the items shown in Table 1.

TABLE 1

| Actuation Method | The present invention Base Configuration |
|---|---|
| | Choke Pressure |
| | Choke 1 position |
| | Choke 2 position |
| | Standpipe pressure |
| | Pump stroke counter(s) − number of mud pumps? |
| | Emergency manual switch state |
| Hydraulic only | Hydraulic supply pressure |
| Hydraulic only | Air supply pressure |
| Electric only | Electric actuator performance indicator(s) |

The electric actuator performance indicator(s) are any data items that provide insight into the state and proper operation of the actuator, comprising, but not limited to, torque, temperature, current and supply of power to an actuator. Note that sensors may not be required for all of the listed inputs. For example, an electric actuator may provide position feedback via an analog output current or a network-communicated data value. The user interface displays data to the user and provides and offers control actions.

The activation state of the emergency manual backup method and apparatus of the present invention control state will be displayed in a manner that is easily perceptible from across the rig floor. In one embodiment, a light and sound meter are provided to determine whether and what level of a light or sound notification to the operator is appropriate but must be available over 100 decibels. For example, if the noise level at the rig is below a set level, for example 100 decibels, then an aural notification signal is appropriate. Otherwise the aural notification may be swamped with ambient noise and become imperceptible to the operator. At any given time, one of these states must be true and the other false. The emergency manual backup activation state of true will be a red light and when appropriate, an aural notification. The present invention control state of true will be a green light and, when appropriate, an aural notification.

The use of a yellow light and associated aural notification to show if a given station has control is also provided. The notification light states are as follows: Red—emergency manual backup method is active; Yellow—the present invention control is active, but this station is not in control; and Green—the present invention control is active, and this station is in control. An operator interface enables a station to take control, for example, when any control-related operator input occurs.

The following data will be displayed in a text format at the rig floor console: All of the sensor inputs, except for emergency manual switch state and pump stroke counter; Control mode state in effect (position-set point or pressure-set point); Pump speed(s) in strokes per minute (SPM); Cumulative pump stroke count; and Pressure set point value, when a pressure-set point control is in effect.

Graphical display of selected data is also provided. As shown in FIG. 13, graphical displays comprise a picture of the choke element and seat, showing the choke element position and speed/direction of movement of element; a trace of the choke pressure, with pressure set point displayed when in pressure-control mode; and gauges displaying pressure(s). The design of the data display provides a balance between showing data in task-specific groups (i.e. more screens) and simplicity (i.e. fewer screens) which comprises multiple screens, or screen layouts, which adjust to the task. The user is provided with controls for following input items: Selection of control mode; Selection of control command; Selection of display variations (if any); and Zero cumulative pump stroke count, for each pump.

The present invention, in certain aspects, provides a system with a user interface that provides aural, physical and visual feedback for movement of the choke element. This feedback includes an emulated sound similar to the traditional sound of the current air-over-hydraulic pump and electric actuator, as appropriate, or can be a new sound, such as a clicking. The sound will alert the user to the smallest detectable movement of the choke element. The sound is preferably expressive for any movement, as the sound also communicates the relative speed of movement of the choke element. The user will be able to adjust the volume of the sound at the user interface, from silent to loud (easily audible within five feet of the user interface with typical rig floor background noise). The emulated sound will be heard sooner than the sound it emulates and thus provides a rapid and more accurate means for enabling the operator to determine when the choke element is moving and to enhance operator's experience (knowledge) by building an enhanced mental model of choke movement.

In a conventional choke control system, the operator issues a command to move the choke element, the choke element moves and the air-over-hydraulic pump starts up to build up hydraulic pressure diminished by the choke element movement. The operator uses the sound of the air-over-hydraulic pump starting up to confirm that the choke element has moved. Thus, there is a feedback delay in the conventional system, that is, there is a delay between the time that the choke element moves and the time the air-over-hydraulic pump starts up and the operator hears the sound of the pump. In the preferred embodiment of the present invention, the emulated sound of the air-over-hydraulic pump starts up immediately when the operator moves the choke control joystick without the physical feedback delay encountered by operators in conventional choke control systems. Thus, in on embodiment of the present invention, the operator receives immediate aural feedback that the choke control command is being executed by the choke control system.

The control performance of the present invention is more accurate and quicker than the best control performance attainable by an expert operator under similar flow conditions using the conventional known choke control equipment. The present invention enables an operator to rapidly, accurately and directly control the pressure drop across a choke. One evaluation of the control performance of the present invention is a set of pre-defined control exercises, which are repeatable and can be performed by a human operator with current equipment and a human operator utilizing the present invention. Examples of these exercises are: Starting at a given position, on command move the choke to different relative positions; and Starting at a given pressure and maintaining a fixed flow rate through the choke, change the pressure to different values.

The schedule of positions and pressures in the pre-defined control exercises covers a range of typical operations, such as small changes and large changes, and with the choke element at various initial control positions. The schedule rigorously challenges the capabilities of the human operator, the present invention, the actuator and the choke, within the allowable physical limits of the operational scenario. The evaluation system prompts the human operator at a console user interface provided by the present invention. Voice operator notifications are preferable for delivering the commands.

Installation of certain embodiments of the present invention requires a minimum of tuning/calibration. The tuning/calibration procedure is easily understandable and unambiguous to any qualified service person. A confirmation procedure is provided, in which the service person verifies that the present invention is properly installed and meets all performance requirements. The service person documents the quality of the installation. The verification procedure is automatic and self-documenting. Once the present invention is installed and working properly, there will be no tuning requirements of any kind, nor will any user adjustments be required to maintain high quality control performance over any well conditions encountered.

The present invention provides a user interface, which, in one aspect, is preferably mounted to existing rig floor structure and also provides a pedestal mount with adjustable height, for convenient choke operation. A wireless version is also provided.

The present invention supports real-time two-way data communication, e.g., with Varco International, Inc.'s RigSense and DAQ JVM, and with other commercially available information systems. In one aspect any sensors whose data is used by the present invention (for control and/or display) are directly connected to the present invention.

In one aspect, when the RigSense system is present in an embodiment of the present invention, the RigSense system provides data archiving and expanded data displays functionality to the present invention. The present invention provides a user interface integrated into other systems such as the RigSense system, DAQ JVM and VICIS; Real-Time Well Control, supervisory control specific to well control tasks; and Automated well control, which may be entire process or selected sub-tasks. One of the primary impacts perceived on existing products and services in which integration and/or implementation of the present invention is performed is additional capability for taking control of and/or being in control of the choking operation via a distinct intervention, so that control is clearly being exercised by users at other stations and by automated controllers.

A key factor for efficient utilization and integration of the present invention into the operator's working environment is the present invention's provision of manual controls for high-frequency user control actions in lieu of touch screen control consoles. Additional automated functionality is provided such as automatic pressure-set control for use in association with the touch screen and provides benefit in the control area, particularly in emergency stations.

Turning now to FIG. 19 in an alternative embodiment a touch screen user interface 1800 is provided. As shown in FIG. 19, the touch screen control mode operator interface preferably comprises control touch pads 1810, 1812 and 1814 for large, medium and small incremental movement of the choke control element in the open direction respectively. Control touch pads 1820, 1818 and 1816 provide large, medium and small incremental movement of the choke control element in the close direction.

Turning now to FIG. 20, in an alternative embodiment a touch screen user interface 1900 is provided for controlling the pressure associated with the choke element position. Touch pads 1910, 1912, and 1914 are provided for incremental lowering of the pressure in large, medium and small increments, respectively. Touch pads 1920, 1918, and 1916 are provided for incremental raising of the pressure in large, medium and small increments, respectively. Aural and visual feedback as described above are provided in association with operation of the touch screen interface of FIG. 19 and FIG. 20.

In another embodiment, the present invention is implemented as a set of instructions on a computer readable medium, comprising ROM, RAM, CD ROM, Flash or any other computer readable medium, now known or unknown that when executed cause a computer to implement the method of the present invention.

The present invention provides a method and apparatus for remotely monitoring, analyzing and affirmatively notifying appropriate personnel of problems and events of interest associated with an oil recovery system comprising hundreds of oil rigs over a vast geographical area or a single rig. The present invention provides a monitoring and reporting system that is referred to as a Health Check system. The present invention provides a variety of performance, process and equipment monitoring Health Checks and equipment sensors at each oilrig in an oil recovery system. The results of selected diagnostics, which are run on each oilrig, are reported to a central server. The central server populates a data base for the oil recovery system, displays a red/yellow/green/gray color coded report for an entire oil recovery system and affirmatively alerts appropriate personnel of actions required or advisories to address events associated with an oilrig in an oil recovery system. The Health Checks performed at each oilrig are configurable at the individual rig and from the central server or other processor associated with either the oilrig or central server. The central server need not change its reporting and display program when changes are made to a health check at an oilrig. The present invention provides a dynamic oilrig status reporting protocol that enables population and display of a tree node structure representing an entire oil recovery system or single oilrig status on a single screen. Thus, the present invention enables rapid visual or aural affirmation of a system Health Check.

Health Checks are not the same as alarms. An alarm is an immediate notification to an operator that a known unacceptable condition has been detected, requiring the operator's awareness of it and often some action by the operator. A Health Check may use alarms in its logic, but it is by nature different than an alarm. A heath check is more general and more diagnostic than an alarm, and does not require immediate action, at least not on the oilrig. In the present invention, a problem is reported to a central server for reporting and diagnosis to service personnel. A Health Check can apply to any equipment component or process, sensors, control systems, operator actions, or control processes, etc.

The Health Check system comprises software containing test logic. The logic is configurable so that inputs, outputs and logic can be selected by a user to test and look for any condition or event associated with an oilrig or oil recovery system. The overall system comprises Health Checks running in real time on a computer at an oilrig and a communications network connecting the oilrig to a central server to move data from the rig of a group of rigs to the server. The server displays the results in hierarchical form. The server sends commands, application programs and data to the rig from the server.

The Health Check system of the present invention further comprises a central database populated with dynamic status reported from oilrigs comprising an oil recovery system. The present invention further comprises a web page display for efficiently displaying Health Check results associated with a test, a rig, an area or an oil recovery system. The web page results can be displayed on a computer, cell phone, personal data assistant (PDA) or any other electronic display device capable of receiving and displaying or otherwise alerting (e.g., sound notification) a user of the status of the data. The preferred screen is a color screen to enable red/green/yellow/gray display results. Results can also be audio, video or graphically encoded icons for severity reports, e.g., an audio message may state audibly, “situation green”, “situation red” or “situation yellow” or display a particular graphical icon, animation or video clip associated with the report to demonstrate a Health Check severity report. The present invention enables drilling down (that is, traversing a hierarchical data structure tree from a present node toward an associated child or leaf node), into a tree of nodes representing diagnostic status, to a node or leaf level to access additional information regarding a color-coded report.

The present invention also provides a notification system to immediately inform service personnel of problems as necessary, such as a message or email to a cell phone or pager or computer pop up message. There is also a receipt affirmation function that confirms that a notification message was received and acknowledged. Secondary and tertiary notifications are sent when a primary recipient does not acknowledge an affirmative notification within a configurable time limit. A severity report associated with a given problem is represented by a blinking color when it is unacknowledged and remains a blinking color until the given problem is cleared and returns to green or clear status. Severity reports once acknowledged change from blinking to a solid color. Reports that have been acknowledged by one user may be transferred or reassigned to another user upon administrative permission by a system supervisor or by requesting permission to transfer a second user and receiving permission from the second user. A system supervisor can also display a list of users and severity reports being handled by the user, that is, a list of acknowledged and in progress severity reports assigned to a particular user to view and enable workload distribution to facilitate reassignments for balancing the work load.

A dispatch may assign a work order to a group of particular severity reports. Once the work order is completed the system checks to see if the nodes associated with the work order have been cleared. The work order provides a secondary method for determining if nodes associated with a work order have been cleared after a work is complete. The system administrator software program can also automatically check the work order against the node state for a system check.

The advantages provided to the customer of a preferred Health Check system are substantially less down time due to the present invention's Health Check's ability to find or anticipate problems earlier and fixing the problems faster, ideally before the customer becomes aware that a problem has occurred. The present invention reassures the customer that the Health Check system is always on the job and monitoring and reporting on the oil recovery system twenty-four hours a day, seven days a week. A customer or system user can always call in and confirm the status of an entire oil recovery system or single rig with a single call to the central server or a rig and receive a situation report, that is situation red, yellow, green or gray for the oil recovery system or single rig, as requested. The present invention enables more efficient use of operational service personnel. The present invention finds and reports problems, potential problems and trigger events of interest, which enables rapid response and recovery in case of actual and/or potential equipment or operator malfunctions or the occurrence of a particular event. The present invention also helps to find problems at an early stage when the problems are often easier to fix, before catastrophic failure, thus creating less impact on the customer's oil recovery system or individual oilrig. Health Checks according to the present invention provide a method and apparatus for providing an application program that acts as an ever-vigilant set of eyes watching an entire oil recovery system or single rig to ensure that everything is okay, that is, operational.

In certain embodiments, all results for each oilrig in an oil recovery system or individual oilrig or equipment are worst-case combined so that the worst-case severity report bubbles to the top of the reporting tree and is reported as the status for an entire oil recovery system, oilrig(s), event of interest, process, or equipment being analyzed. As discussed above, red is a worst-case severity report, followed by yellow severity report and then green is the least severe report. Gray indicates no data available. Thus, if one or more tests reporting a red status is received from an oilrig, the red status bubbles up past all yellow and green status reports and the status for the rig and the entire oil recovery system in which the rig resides is shown as red. Once the red report is cleared, yellow reports, if any, bubble up and the status of the oil recovery system, rig or equipment being viewed is shown as yellow, if a yellow report is in a node tree transmitted from any oilrig in an oil recovery system. The status for a single oilrig bubbles up the worst-case report as well, however, localized to the single rig or rigs under investigation, unless grouped. When grouped the worst-case status for the group is reported. For example, if three rigs were reporting the following scenario is possible: Rig 1 reports red, rig 2 reports yellow and rig 3 reports green. The status for a group selected to include rigs 1, 2 and 3 would be red. The status for a group selected to include rigs 2 and 3 would be yellow. The status for a group selected to include rig 3 only would be green. Subsections within a rig can also be selected for a color-coded status report. Preferably, the gray is not cleared. Usually, if the test were not conducted for any reason, the status would take gray color.

The present invention enables testing at the nodes of a bottom up tree structure representing an oil recovery system, a single rig therein, or an equipment in an oilrig, wherein the nodes carry the results to the top for easy visualization and use. The present invention also provides a dynamic reporting protocol for data transfers from an oilrig to a central server wherein level identifiers are provided to transfer data and its structure in a single packet transfer, thus enabling dynamic data base population and display of reports from an oilrig. The results are presented on a web page or reported to cell phones, computers, pagers, personal data assistants or otherwise affirmatively reported other wise to appropriate personnel. In a preferred embodiment, reports are acknowledged by a first recipient or a second recipient is selected for receipt of the report when the first recipient does not acknowledge receipt, and so on, until a recipient has received and acknowledged the report. Alternatively multiple recipients may simultaneously get the notification.

The present invention is automatically scaleable and extensible due to the modular and dynamic nature of its design. Tests can be easily created, added or deleted and parameters added or modified on an oilrig equipment test or Health Check without reprogramming or changing the central server's database population, data reporting and data display applications. The reporting can vary between broad coverage and specific coverage, that is, a status report can included data for an entire oil recovery system comprising over 100 oilrigs and/or specifically report status for a single oilrig of interest concurrently.

The present invention provides early warning of potential and actual failures and also provides confirmation of product performance and usage. A set of automated Health Checks and diagnostic tests is selected to run in real time on an oilrig. Status from the test is reported continuously via a communication link between the oilrig and a central server. The present invention provides insight and analysis of equipment, processes and equipment usage on an oilrig. The present invention monitors alarms and parameter limits to assess necessary action and perform affirmative notification of appropriate personnel.

The present invention provides quick response, real-time monitoring and remote diagnostics of the automation and control systems running on oilrigs comprising a fleet of oilrigs or an oil recovery system to achieve maximum rig performance while maintaining optimum personnel allocation. A service center is connected to the oilrigs through an Internet based network. System experts make real-time data and logged data from the oilrigs available for perusal and analysis in a central facility or at distributed locations. The web site of the present invention provides access to current operational status as well as to historical operation and performance data for each of the rigs comprising an oil recovery system.

Health Check tests are configurable so that new tests can be created, added or deleted and parameters changed for execution at an oilrig without the necessity of programming. A simple user interface is provided wherein a user at the central server or at an oilrig can select a test from a library of existing tests, or create a new test using a scripting language, natural language interface or pseudo language is provided which generates a script defining inputs, outputs and processing logic for a test. The script is compiled and sent to the rig for addition to existing Health Checks running on the rig. The user interface also enables modification or addition and deletion of parameters associated with a Health Check or test.

Notifications can be an immediate message when a problem is detected or an advisory notification. The notification is sent to expert service personnel associated with the central server or can be directed to a service manager or local service person closest to the rig needing service. For each rig and problem type, a particular person or service personnel category is designated for receipt of a notification. Secondary and tertiary backup personnel and personnel categories are designated as a recipient for each notification. Affirmative notifications must be acknowledged by the recipient so that the problem is acknowledged and someone has taken responsibility for the problem. If an affirmative notification is not acknowledged within a configurable time period, then a secondary or tertiary recipient is notified until the problem is acknowledged. Reliability reports are generated by the present invention showing performance summaries for oilrigs, comprising up time, response, problems detected and solutions provided. These reports provide an objective basis for formulating an evaluation of the Heath Check system's efficiency.

The results from a rig include processed inputs from the rig. No processing is required at the central server, other than display, storage and alerts to appropriate personnel. The oilrig Health Checks and tests are configurable so no programming is required to implement a new test or change logic or parameters for an existing test. A field engineer or central server personnel can add a new test without requiring a user to perform a programming change. The present invention provides a local or remote user interface, which provides a simple interface for describing a test and logic. The interface comprises an iconic presentation, pseudo language, script or a natural language interface to describe a test's input(s), processing logic and output(s). The user interface interprets a user's inputs and converts the user's input into a scripting language. The script language is compiled and sent to the rig on which the new or augmented test is to be performed. The new test is added to a library of tests from which a user may choose to have run at a rig. Test modules can be deleted, added, parameters changed, and updated from the oilrig, the central server or from a remote user via a remote access electronic device.

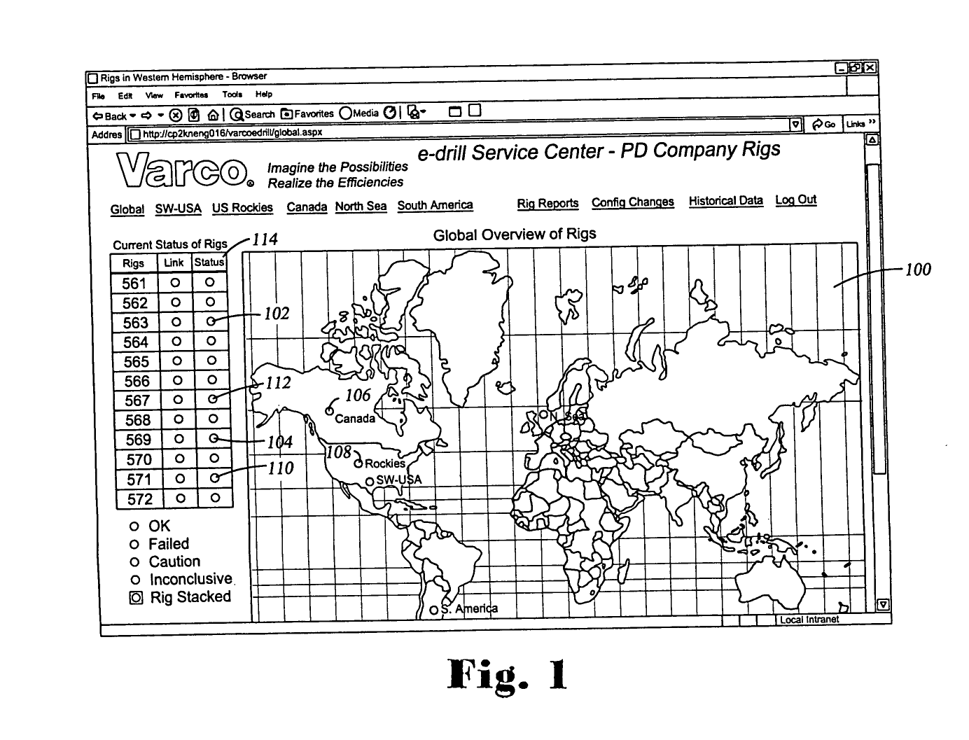

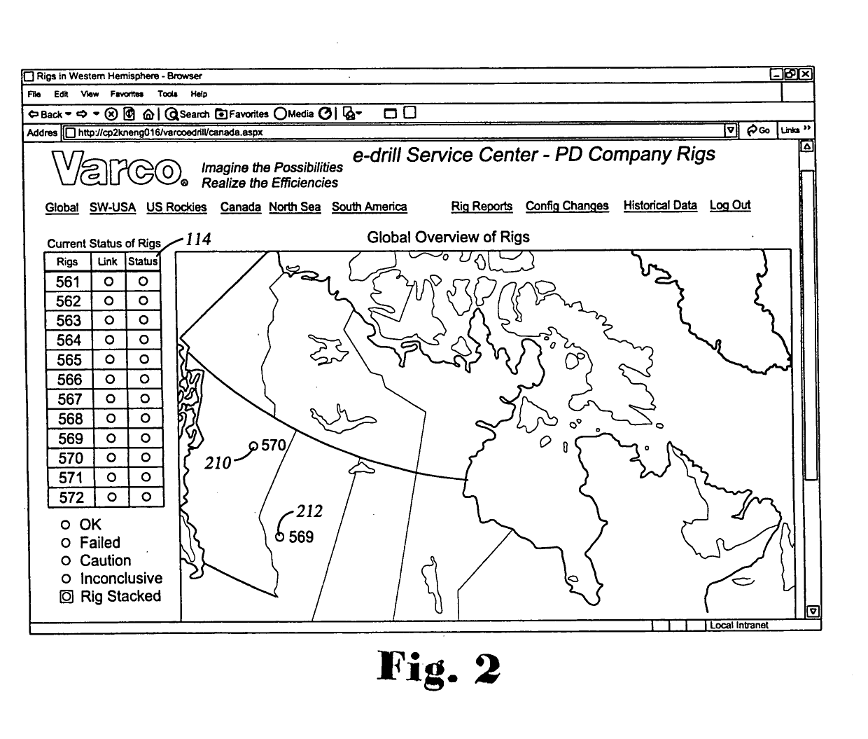

Turning now to FIG. 1, a preferred embodiment of the present invention is shown illustrating a global overview 100 of all rigs comprising an oil recovery system. As shown in FIG. 1, a map pinpoints geographic locations of the rigs in the system of interest. A web page display is presented on a personal computer or PDA. The web page generated by the central server presents a geographic view of an oil recovery system. In FIG. 1, rig number 563 102 and rig number 569 104 is shown with a red status, indicating that a condition or reporting event of interest has occurred at rig number 563 and number 569. Rig number 569 106 is in Canada and rig number 563 108 is in the United States. Rig number 571 110 has a yellow status and rig number 567 112 has gray status. All other rigs shown in FIG. 1 have a green status. When a system user clicks on rig number 569 106 or the Canadian region, the display of FIG. 2 appears. FIG. 2 shows the Canadian region, which includes rig number 569. Notice that rig number 570 210 has a green status is now displayed on the more detailed Canadian region display. The green status geographical indicator for rig number 570 is suppressed and not shown in the broader display of FIG. 1 so that the more severe red status of rig number 569 would be immediately visible and evident on the display of FIG. 1. Once a user implicitly acknowledges the red status for rig number 569 by clicking on rig number 569, the present invention displays the less severe status of rig number 570. Thus, the more severe status of rig number 569 bubbles up in the geographical display and is displayed first at a higher level in the geographical display hierarchy. Note that the green status indicator of rig number 570, however, is shown in the panel 114 of FIG. 1 and FIG. 2. Thus, the present invention presents a hybrid display in which all Health Check results are available in the panel 114 but worst case results are presented in the geographical displays of FIG. 1 and FIG. 2.

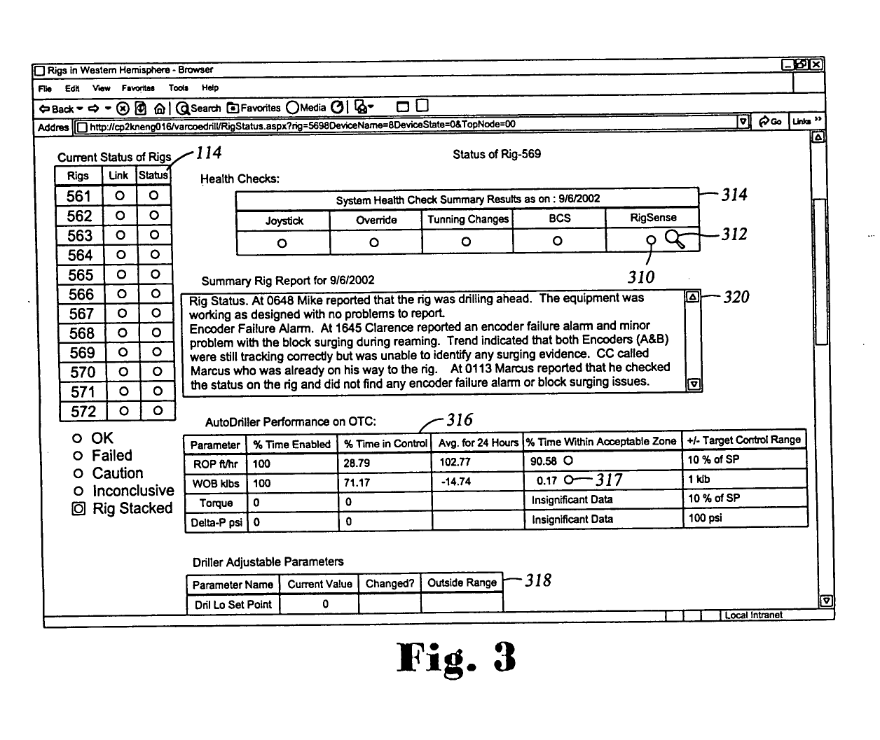

Turning now to FIG. 3, the status display 314 of FIG. 3 for rig number 569 is shown when a user clicks on rig number 569 104, 212 in FIG. 1 or FIG. 2. FIG. 3 illustrates that a rig number 569 component, “Rigsense” has a red indicator 312. The Magnifying Glass icon 312 shown adjacent red indicator 310 indicates that more information is available regarding the red indicator 310. Notice that there are also additional panel displays 316 and 318, which are configurable, which perform additional informative functions. A summary panel 320 is displayed for rig number 569. The summary status panel contains operator reports from the oilrig. These operator reports are useful in diagnosing status and formulating a plan of action or notification. An AutoDriller status panel 316 is also displayed. Note that the Weight on Bit (WOB) indicator 317 is red in the AutoDriller status panel. A driller adjustable parameters panel 318 is also displayed.

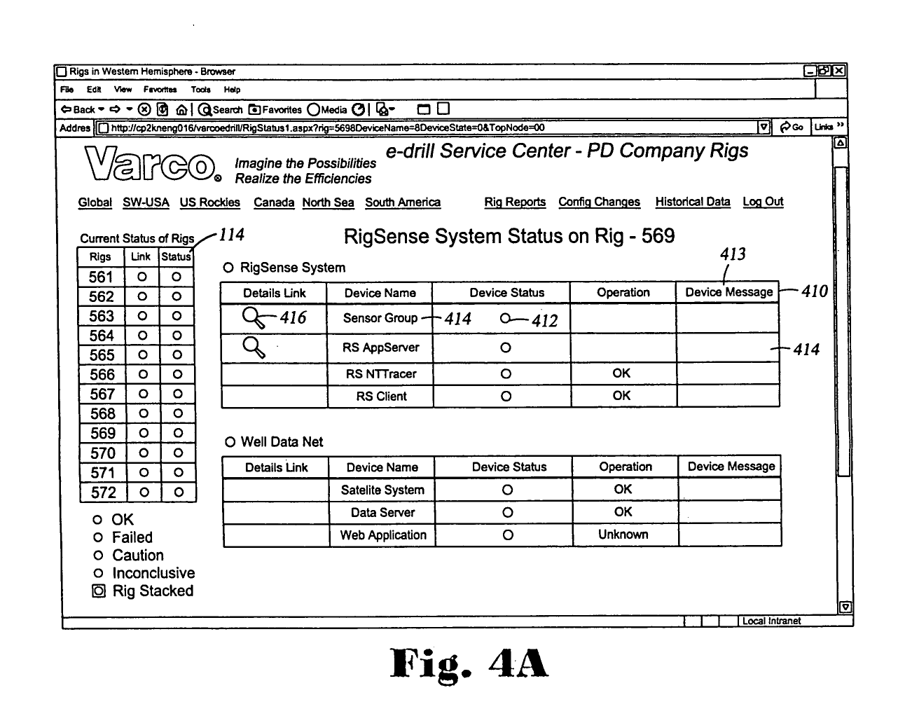

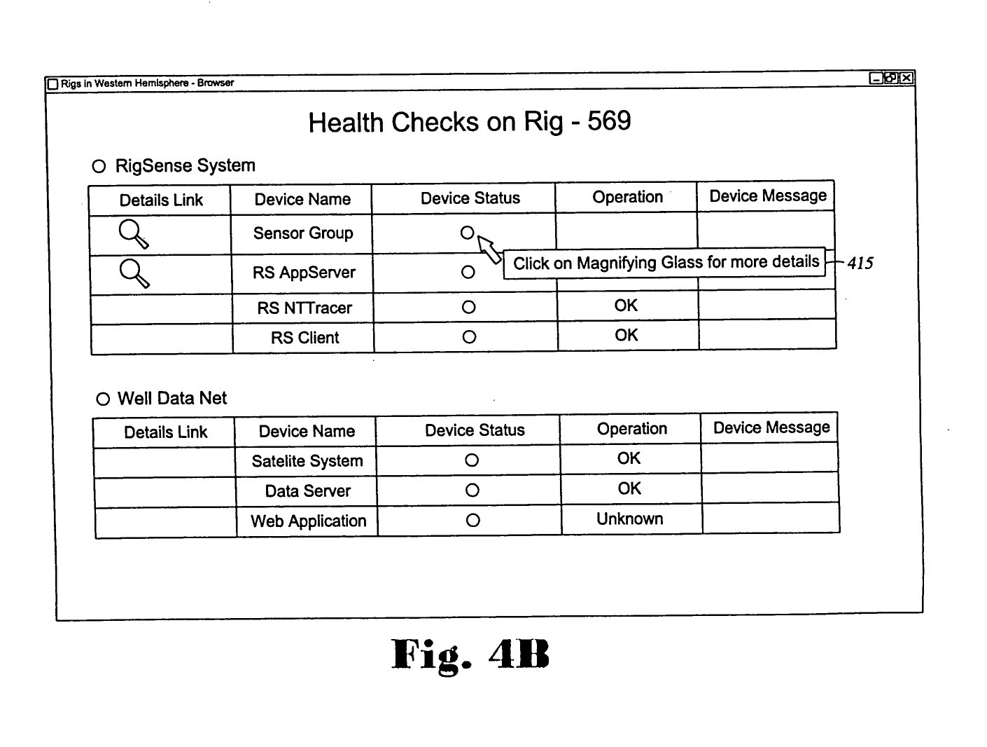

Turning now to FIG. 4A, continuing with rig number 569, clicking on the red indicator for Rigsense status in FIG. 3, brings up the display for the Rigsense system panel status 410 as shown in FIG. 4A. Note that the device message block 413 may contain a part number 411 to expedite repair of a failure as reported. The particular part number and or drawing number necessary to perform a given repair associated with a given problem or severity report may be difficult to find in a vast inventory of parts and part numbers and drawings associated with a given failure. Otherwise, the recipient of a failure report may have to search via key words through a vast inventory of parts, part numbers and drawings associated with a given failure. Moreover, the user may not be familiar with a particular vendor's part numbering system, thus, provision of the part number is a valuable expedient to trouble shooting.

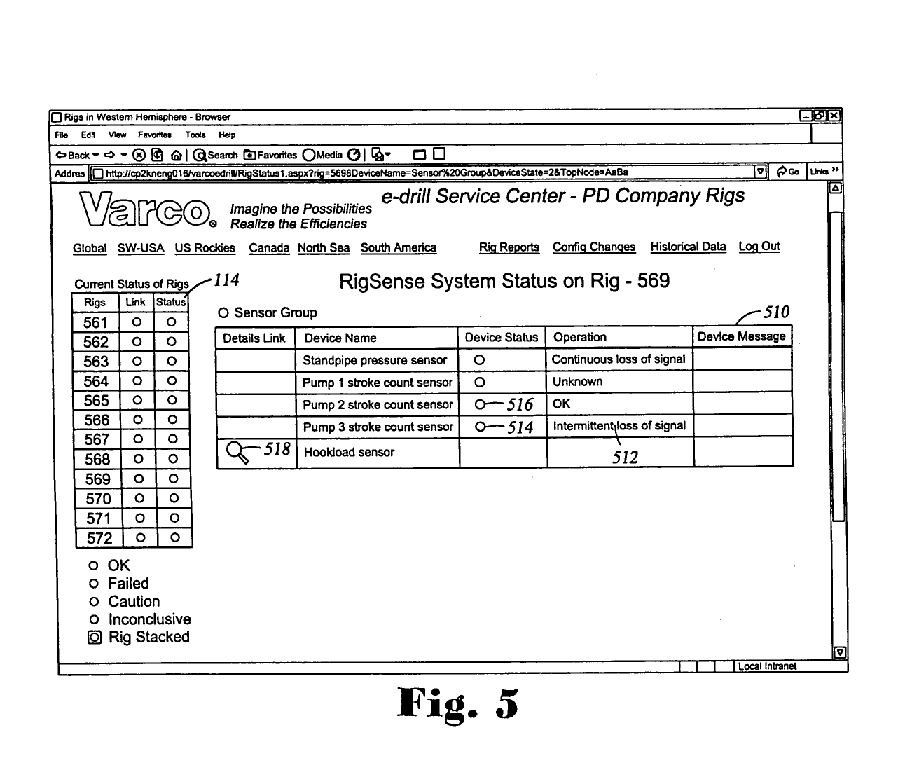

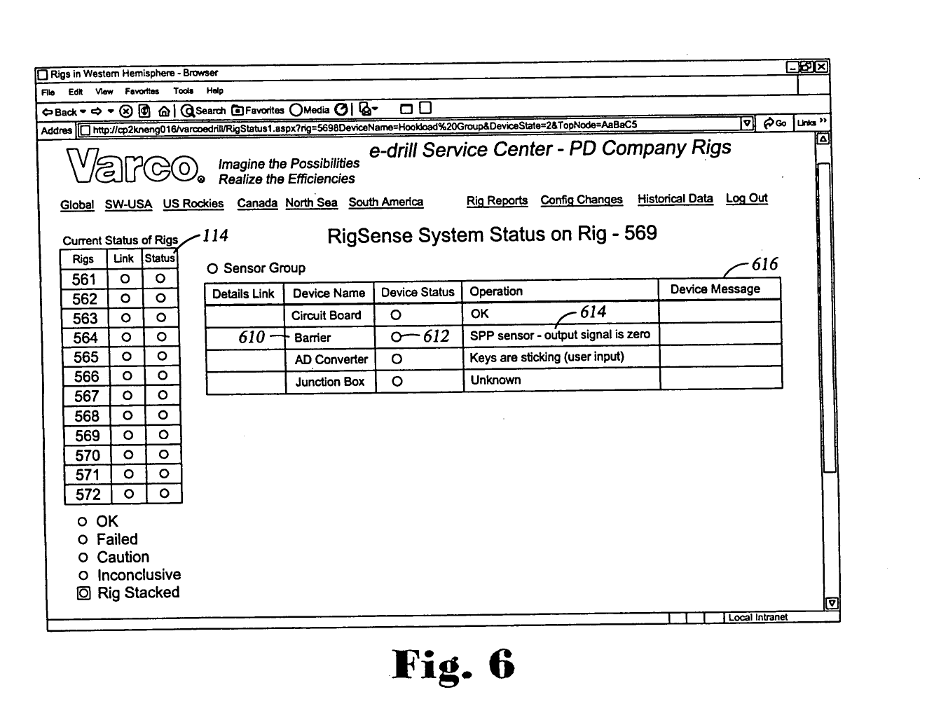

FIG. 4A shows that the sensor group device status 412 is red with a Magnifying Glass icon 416 indicating that more information is available for the red sensor group device status indicator 412. In an alternative embodiment, as shown in FIG. 4B, a pop-up message 415 appears along with the Magnifying Glass stating “Click on Magnifying Glass for more details.” Clicking on the red sensor group 414 device Magnifying Glass 416 brings up the display 510 of FIG. 5, showing a detailed status for the sensor group device status. Note that there are two red indicators shown in FIG. 5 for device status in the sensor group as follows: “Pump 3 Stroke Count Sensor” 516 and “Hookload Sensor” 514. Note that the Pump 3 red device status indicator has an informational comment 512 in the operation column of the display of FIG. 5, stating “Intermittent Loss of Signal.” The Hookload Sensor red device status indicator present an adjacent Magnifying Glass icon 518 with a message indicating that more information is available for the device status of the Hookload sensor by clicking on the Magnifying Glass icon. Clicking on the Magnifying Glass indicator 518 for the Hookload sensor brings up the Hookload sensor panel 616 of FIG. 6, which shows that the device name “Barrier” 610 had a red device status indicator 612. The red device status for the Barrier displays an Operation message 614, stating, “Excessive ground current”. Each colored indicator and accompanying operation message shown in the preferred displays illustrated in FIGS. 1-6 appeared in line of the Health Check performed at an oilrig and sent to the server in the structured protocol of the present invention.

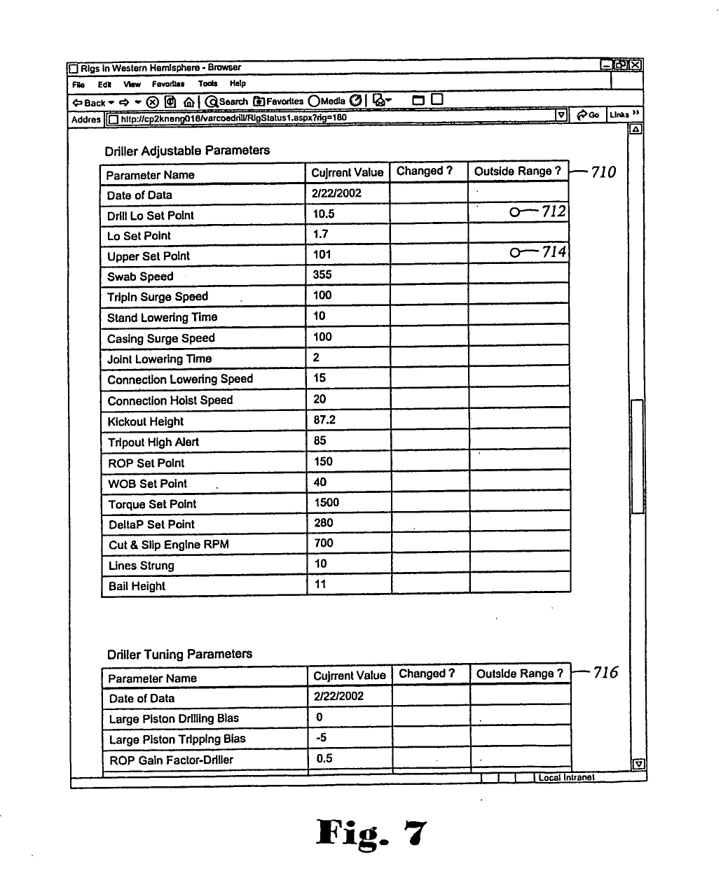

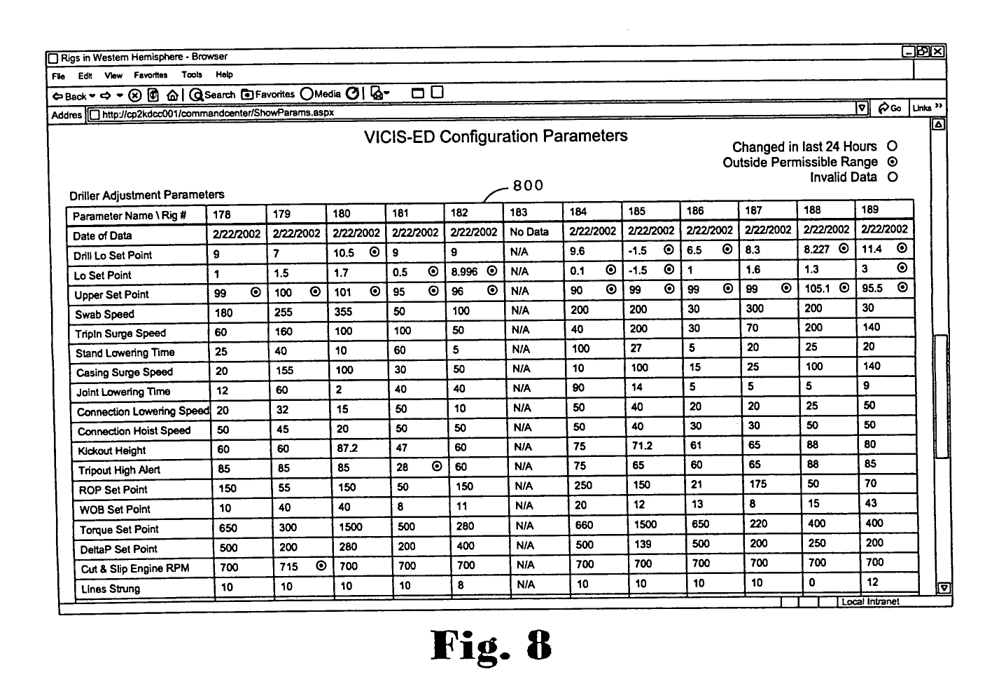

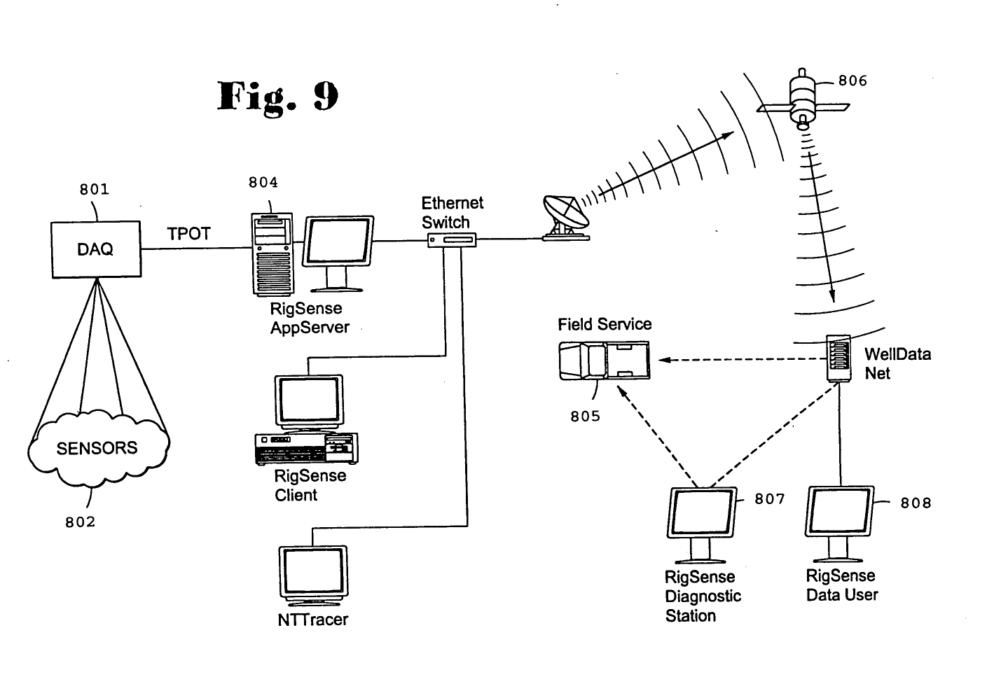

FIG. 7 illustrates a Driller Adjustable parameters display 710 with two red indicators showing that Drill Low Set Point 712 and Upper Set Point 714 are Outside Range. A Drilling Tuning parameters panel 716 is also displayed. Both panels indicate the current value, changed indicator and outside range indicator for each parameter displayed in the respective panels of FIG. 7. The display of FIG. 7 is an alternative tabular display for rig status for a single rig. FIG. 8 illustrates a configuration or driller adjustable parameters status panel 810 for rig numbers 178-189. The display of FIG. 8 is an alternative tabular display for rig status for plurality of rigs, e.g., rigs 178-189. Turning now to FIG. 9, a data acquisition system 1010 is shown in an oilrig environment connected to a plurality of legacy or Heath Check sensors 1012, which gathers data from the group of sensors monitoring the rig equipment, parameters and processes. The data acquisition system 1010 sends the acquired data from the sensors 1012 to a computer 1014 on which the preferred Health Check application of the present invention is running. The application of the present invention performs Health Checks logic on the acquired data and reports the results in the structured protocol to a user via satellite 1016 or some other form of electronic communication. A user may monitor health check status and receive notifications via an electronic receiver 1020, diagnostic station 1024 or mobile in field service vehicle 1022.

The present invention is also useful for Process Monitoring, that is, to determine that equipment is being used properly to perform a designated process. For example, if rig operators are using an “override” during a certain system state indicative of a certain process, which is supposed to be run automatically rather than manually overridden, the present invention can perform a health check to detect this event of interest and report it to the central server. Knowledge of this occurrence enables central server personnel to detect and correct the inappropriate action of the operators. Moreover, the test to detect the inappropriate override stays in the system so that if new operators recreate the problem or trained operators backslide into using the manual override inappropriately, the central server personnel will be notified so that the problem can be address again. Thus, the Health Check system builds a cumulative base of operational checks to insure that a process on a rig or oil recovery system runs in optimal fashion.

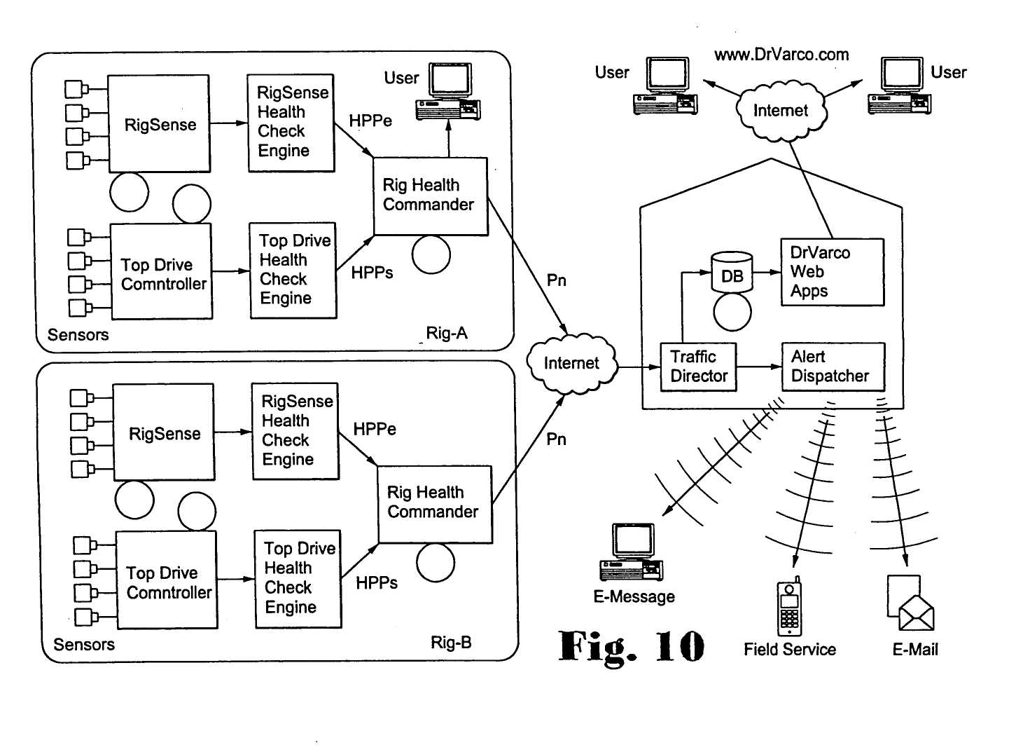

Turning now to FIG. 10, FIG. 10 is an illustration of a preferred Health Check system reporting health checks of multiple equipments, processes or systems from multiple oil rigs to multiple users.

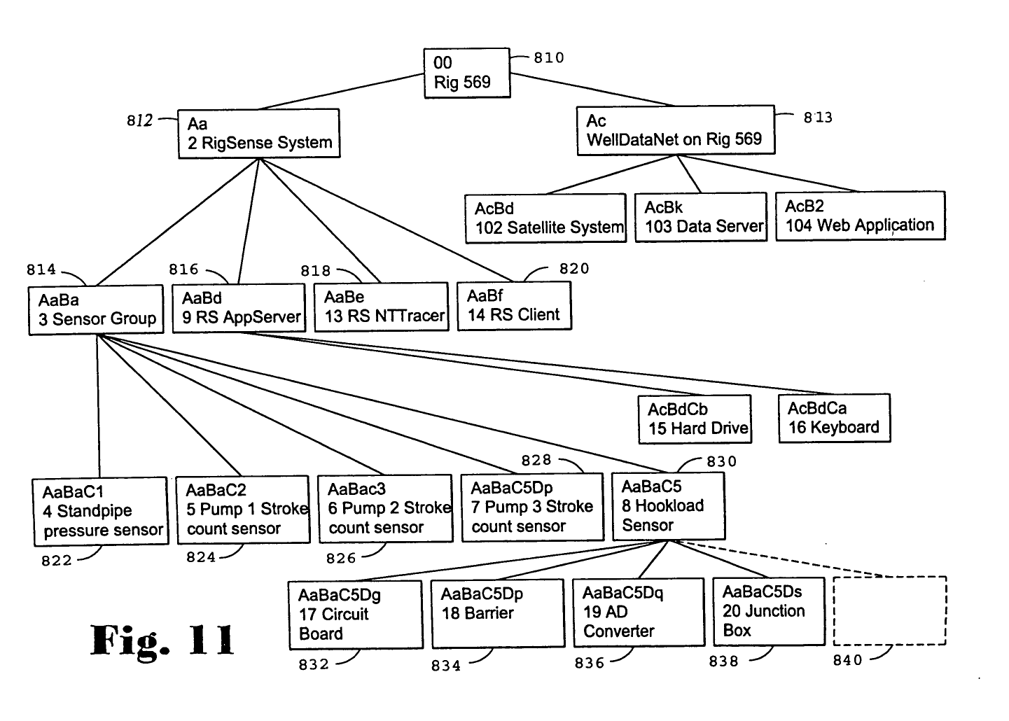

Turning now to FIG. 11, the results of the tests are reported to the central server in a special protocol that contains heath check results data and describes the manner in which the data is constructed so that the data can be placed in a logical data structure or tree format and displayed. Note that the root node 810, usually an oilrig has a designation of “00”. The first level of nodes 812, 813 etc. under the root node are named Aa, Ab, Ac, Ad, etc. Each subsequent layer of node is named with the name of the parent node followed by a designation of the current node. For example, as shown in FIG. 11, for a rig number 569, the root node 810 is named “00”, the first level of children nodes under the root node are named Aa 812 and Ac 813. The children of node Aa 812 are named AaBa 814, AaBd 1116, AaBe 818 and AaBf 820 as shown. The children of child node AaBa are named AaBaC1 822, AaBaC2 824, AaBaC3 826 and AaBaC4 828. The children of node AaBaC5 830 are named AaBaC5Dg 832, AaBaC5Dp 834, AaBaC5Dq 836 and AaBaC5Ds 838. A new test could be added to rig 569 number and the Heath Check status could be reported under node AaBaC5Dx 840.

Changes to the Health Checks running on any or all rigs does not require changes to the display or data base population application because the preferred communication protocol defines the data base layout and display layout. The leaf nodes of the tree structure represent Health Check results. Each node contains a test identifier, test result (red/yellow/green/gray), intermediate data, user-entered data and test description. Trouble shooting comments are provided at the central server based on reported errors. Test error codes are included in the node so that messages associated with the error codes are displayed to the appropriate user. Alternately, trouble shooting and other information can also be generated and appended to the results of the tests at rig site. Thus, no processing to determine rig status is done at the central server. Notifications are sent when deemed necessary by the application. Notification logic is configurable by service personnel at the central server or at the oilrig. Notification logic dictates that notifications are sent when an event occurs and the event has been selected for reporting as a notification to a user. The notification logic and a list of appropriate notification recipients in order of priority, that is, who to contact first, is retained at the central server. The event can be a report on an equipment status, process execution or an operational item. A user can check in with the central server of present invention to obtain a real time report of the status of an oilrig or multiple oilrigs. The requesting user will receive a severity report message indicating the status of the rig, for example, “okay” or “red/yellow/green/gray.”

The following are examples of Health Checks in a preferred embodiment of the present invention. In this example, VICIS-ED is a drilling rig information and control system; it includes control of the drawworks via a joystick.

Rig Health Check: Auto-Drilling Performance

Auto-drilling Performance: In a preferred embodiment of the present invention, an autodriller in VICIS-ED controls ROP, WOB, torque and/delta-p parameters of the drilling process; it does this by controlling rate of line payout on the drawworks to limit the controlled parameters to setpoints specified by the driller. This health check tests verifies that the auto-driller is maintaining these parameters within acceptable limits. Acceptable control ranges typically have the following default values:
WOB: set point .+−.1000 lbs
ROP: set point .+−.10% of set point
Torque: set point .+−.10% of set point
Delta-P: set point .+−.100 psi

At any given time during drilling, only one controller is in control. If no drilling occurred or auto drilling is not active during the last 24 hours this check is not possible and will not be included in the report. For each of the four controllers, the DCQA application computes the percent of time the feedback is within the allowable range. For each controller, this test is performed once a second when the controller has been in control for a minimum of 10 seconds. A count of acceptable and total test results is accumulated for each controller. At 6 am for the previous 24 hours, this test computes the percent of time each controller's feedback was within the specified range, for all valid tests. If at least twenty tests for a controller were not done in the last 24 hours (which includes when there was no drilling or if the autodriller was not used), that controller's health check result is gray. Otherwise, the percentage of acceptable control counts is compared to pre-set values to categorize the result as red, yellow or green.

Health Check: Use of System Keyed Override Switch

VICIS-ED provides a keyed override switch, whose use should not be required for routine operation of the system. In 24-hour periods, the status of this switch is monitored once a second, resulting in a count of times the switch was activated. A count greater than zero produces a red result for this health check, otherwise it is green. If this switch is used, this check is deemed failed and the number of engagements of this switch is documented in the command center log. This test monitors the state of the keyed override switch once a second and counts the number of times the switch has been pressed. If the switch is on when the test starts, that is counted as a key press. At 6 am for the previous 24 hours, the health check is conducted, which consists of comparing the number of switch activations to a count of zero. If the switch has been pressed one time or more, the health check result is red; otherwise, it is green.

Health Check: “Joystick Control”

Joystick Control: The joystick controls the movement of the block; when hoisting it controls engine speed and when lowering it controls application of brake. For each 24-hour period, joystick movement and the resulting block velocity changes are observed. This test uses a comparison between joystick position (hoist, lower or neutral) and block velocity. In general, both parameters should be moving in the same direction. This test consists of identifying times where the joystick and the block are moving in opposite directions. The rules for this test procedure are specific to the joystick position.

Health Check: Joystick in Hoist/Lower Position

This Health Check watches for a minimum of three consecutive joystick positions in same direction (i.e. all hoisting or all lowering) and compares the joystick position and block velocity in the third sample. If the joy stick position and the block velocity are in opposite directions, the Health Check increments the appropriate joystick hoist or lowers the error count. This test is not performed while the system is in keyed override or in a slip-and-cut mode.

Health Check: Joystick in Neutral Position

This Health Check detects watches for a minimum of three consecutive joystick positions in neutral direction. If the block is rising or falling in the third sample, it increments the joystick neutral error count. This Health Check is not performed while the system is in keyed override or in slip-and-cut mode. The “block falling” portion of this test is not performed when the auto driller is on. If the sum of the error counts for all of the above tests are greater than zero for the previous 24 hours, the health check result is red; otherwise, it is green. The joystick position is determined using the hoist and lower switches in the joystick assembly. The test also uses the following parameters:

Sign Conventions and Tolerances:

Block velocity >1.0 ft/min upward block movement.

Block velocity <−1.0 ft/min downward block movement.

Health Check: Use of Auto-Drilling

It is assumed that the autodriller should be used and provide optimal performance during most drilling operations.

To conduct this test, the Health Check monitors the bit-on-bottom state and auto-driller state from the drill logic in the drilling instrumentation system. It computes the percent of drilling time when the auto driller is in use on a one-second sampling as follows:
100.times.(number of times AD on AND bit-on-bottom)/(number of times bit-on-bottom).

At 6 am for the previous 24 hours, the test outputs the percent of drilling time the auto driller was used and this health check. This Health Check consists of comparing this percentage against a threshold of 98%. If the percentage is <98%, the health check result is red; otherwise it is green. If no drilling was done, the health check result is gray. The percent of time on-bottom drilling is also computed, based on bit-on-bottom status.

Health Check: System Settings Changes

A large number (more than 100) of system setting parameters exist in VICIS-ED; some are initial system settings, some are expert tuning adjustments and some are operational in nature and driller-specified. Many of these parameters preferably do not require changing on a daily basis, and knowledge of which parameters changed and how is vital for providing support to maintain system performance and ensure optimal usage. This test monitors all tuning parameters and maintains a count of changes by parameters and by groups of parameters (example—driller-initi-ated parameters). The following parameters are monitored, grouped as follows:

The following are User/Driller-Adjustable Tuning Parameters: Large Piston Bias for Tripping; Large Piston Bias for Drilling; Driller ROP Gain Factor-Adjust; Driller WOB Gain Factor-Adjust; Driller Torque Gain Factor-Adjust; and Driller DeltaP Gain Factor-Adjust.

Driller-Adjustable Operational Parameters: Drill Stop Point; Low Set Point; High Set Point; Swab Speed for Trip Out; Surge Speed for Trip In; Stand Lowering Time; Surge Speed for Run Casing; Joint Lowering Time; Connection Lowering Speed; Connection Hoisting Speed; Trip In Kick Out Alert; Trip Out Height Alert; ROP Set point; WOB Set point; Delta P Set point; Torque Set point; Engine Cut Slip Speed Set point; Lines Strung; and Bail Length.

The following are Password-Protected Parameters: Block weight; Brake horsepower; Encoder resolution; Brake air supply alarm low limit; Brake air supply alarm high limit; Engine tuning gain; Engine tuning integral; Brake hoisting tuning gain; Brake hoisting tuning integral; Brake lowering tuning gain; Brake lowering tuning integral; ROP loop tuning gain; ROP loop tuning integral; WOB loop tuning gain; WOB loop tuning integral; Torque loop tuning gain; Torque loop tuning integral; Delta P loop tuning gain; and Delta P loop tuning integral.

This test records the value for each parameter upon startup. On a 24-hour basis starting at 6 am CST, the test maintains a count of the number of times each parameter's value is changed, and if a parameter was outside the preferred range.

The application outputs the following at 6 am CST: a “value has changed” state for each parameter; a “value was out of range” state for each parameter; count of parameters changed per group; color-coded test result for each group; and color-coded test result for System Settings.

The test results for each parameter are color-coded in the following order:
If (parameters was out of preferred range):red,
else, If (parameters was changed):yellow,
else
If (parameter input was not valid):gray (“test environment failure”),
Else:green.
   The group test results are color-coded as the “worst case” test result of all the parameters in the group.

Based on the above results, the System Settings test status is color-coded in the following order:
If (one or more of the above tests are red):red,
else If (one or more of the above tests are yellow):yellow,
else If (one or more of the above tests are “test environment failure”):gray(“test environment failure”),
else:green.
Health Check: BCS Function

The BCS (block control system) limits the driller's operation of the block such that it does not exceed safe limits of operation. This check tests the operation of block control system compared to the preset limits it is required to enforce. To pass the test, the block should operate within the position/velocity envelope enclosed by upper and lower set points and maximum velocity set points. Pre-determined tolerance ranges are specified upon installation. The specification for VICIS-ED BCS operation is as follows:
Elevator position cannot go past 4 ft above high set point.
Elevator position cannot go past 1 ft below low set point.
Block velocity cannot exceed dynamic system-specified maximum velocity (specific to hoisting or lowering).
   The test maintains a count of each of the following failures:
Elevator position >(high set point +4.0).
Elevator position <(low set point −1.0), if auto driller is off.
Elevator position <(drill stop point −1.0), if auto driller is on.
Elevator velocity >(1.10.times.max. lowering speed), if lowering
Elevator velocity >(1.10.times.max. hoisting speed), if hoisting.

The health check is not done if either the range override or the keyed over ride are on, or if in slip-and-cut mode. These counts are reset to zero at 6 am and are maintained on a 24-hour basis. At 6 am, the counts will be summed. If this sum is greater than zero, the health check result is red; otherwise, it is green.

These health checks include rules to qualify inputs as valid. Examples of these rules are:
Elevator position: at least one value has been received, AND current value must be between −20 ft and 150 ft.
Block velocity: at least one value has been received, AND current value must be between −5000 ft/min and 5000 ft/min.
Keyed override switch state: at least one value has been received, AND current value must be 0 or 1.
Rate of penetration: at least one value has been received, AND current value must be >=0.
Weight-on-bit: at least one value has been received
Torque: at least one value has been received, AND current value must be >=0
Lines strung: at least one value has been received, AND current value must be from the values 2, 4, 6, 8, 10, 12, 14, 16, 18, 20.
Joystick Hoist Switch State; Joystick Lower Switch State: at least one value has been received, AND current value must be 0 or 1.

In another embodiment, the present invention is implemented as a set of instructions on a computer readable medium, comprising ROM, RAM, CD ROM, Flash or any other computer readable medium, now known or unknown that when executed cause a computer to implement the method of the present invention.

The present invention is described herein for use on drilling rigs, however, numerous other applications are intended as appropriate for use in association with the present invention. In a preferred embodiment the present invention replaces conventional choke control methods and apparatuses with an improved digital choke control system that provides a more accurate and faster response choke control than prior systems while maintaining the look and feel of prior known choke control systems. The user adapts to perceive the present invention as the preferred manner of controlling the choke versus known conventional choke control methodologies and apparatuses. The present invention also enables direct control of both pressure and position associated with a choke.

The present invention is a replacement for any application requiring the use of a choke. Preferably the user relies on the conventional known choke control methods only as emergency manual backup stations used to back up the improved choke control method and apparatus provided by the present invention. It is expected that the user population will eventually develop enough familiarity and confidence in the choke controlling method and apparatus of the present invention that the user interface provided by the present invention will become the only choke-control-related component located on the rig floor. Eventually, it is expected that in order to simplify rig operations and create more space on the rig floor, that users will exclusively utilize the present invention to the exclusion of conventional choke control methodologies and con Fig. rigs without conventional choke control equipment on the rig floor.

The present invention, therefore, in at least some, but not necessarily all embodiments, provides a system for diagnosing and controlling a choke, the choke used for choking in wellbore operations associated with a wellbore in the earth, the system including a positioner for moving a choke mechanism of a choke, a choke isolation valve connected to the choke for selectively isolating the choke, a processor for controlling the positioner and for selectively commanding the positioner to move the choke mechanism while the choke is in standby mode. Such a system may have one or some (in any possible combination) of the following; wherein the processor automatically commands the positioner to move the choke mechanism into standby mode; wherein the system includes sensor apparatus for sensing conditions of the wellbore operations, the sensor apparatus for producing signals indicative of said conditions and for transmitting said signals to the processor, the sensor apparatus in communication with the processor, and the processor includes a computer readable medium with computer executable instructions for commanding the choke to remain in standby mode based on said conditions; wherein the system includes sensor apparatus for sensing conditions of the wellbore operations, the sensor apparatus for producing signals indicative of said conditions and for transmitting said signals to the processor, the sensor apparatus in communication with the processor, and the processor includes a computer readable medium with computer executable instruction for commanding the choke to enter standby mode based on said conditions; wherein the processor includes a computer readable medium with computer executable instructions for scheduling periodic operation of the choke and for then periodically operating the choke; wherein the processor includes a computer readable medium with computer executable instructions for diagnosing the choke; wherein the system includes sensor apparatus for sensing conditions of the wellbore operations, the sensor apparatus for producing signals indicative of said conditions and for transmitting said signals to the processor, the sensor apparatus in communication with the processor; wherein the system includes sensor apparatus for sensing conditions of the wellbore operations, the sensor apparatus for producing signals indicative of said conditions and for transmitting said signals to the processor, the sensor apparatus in communication with the processor, and the processor includes a computer readable medium with computer executable instructions for commanding the choke to exit the standby mode based on user input or on said conditions; a mode sensor connected to the choke for determining when the choke is in a standby mode, the mode sensor in communication with the processor; a choke position sensor connected to the choke for determining the position of the choke mechanism, the choke position sensor in communication with the processor; a processor memory in the processor and containing diagnostic instructions for performing a choke diagnostic; the processor including a computer readable medium with computer executable instructions for producing a result based on a diagnostic performed by the system; the processor including a computer readable medium with computer executable instructions for producing an analysis for determining whether a choke failure has occurred; the processor including a computer readable medium with computer executable instructions for producing an analysis for predicting that a choke failure will occur; a pressure sensor for measuring a pressure of fluid circulating through the wellbore to produce a pressure measurement, the pressure sensor in communication with the processor, the processor including a computer readable medium with computer executable instructions for determining if said pressure measurement relative to a pre-determined pressure threshold indicates that standby mode is appropriate; the processor including a computer readable medium with computer executable instructions for performing a choke mechanism speed diagnostic; and/or the processor including a computer readable medium with computer executable instructions for performing a choke mechanism position diagnostic.

The present invention, therefore, provides in some, but not necessarily all, embodiments a system for diagnosing and controlling a choke, the choke used for choking in wellbore operations associated with a wellbore in the earth, the system including a positioner for moving a choke mechanism of a choke, a choke isolation valve connected to the choke for selectively isolating the choke, and a processor for controlling the positioner and for selectively commanding the positioner to move the choke mechanism, the processor for diagnosing the choke, transmitting information regarding a diagnosis to a control system, and for selectively periodically activating the choke. Such a system may have a processor that enables operation of the choke during the selective periodic actuation of the choke, confirms acceptable status of the choke, provides notice of potential problems with the coke, and/or provides notice of existing problems with the choke.

The present invention, therefore, provides in some, but not necessarily all, embodiments a system for diagnosing and controlling a choke system, the choke system used for choking in wellbore operations associated with a wellbore in the earth, the system including a plurality of chokes, valve apparatus and associated conduit apparatus for selectively operating a first choke of the plurality of chokes, while at least one non-operational choke is maintained in standby mode, each of the chokes of the plurality of chokes further including a positioner for moving a choke mechanism of a choke, a choke isolation valve for selectively isolating the choke, and a processor for controlling the positioner and for selectively commanding the positioner to move the choke mechanism while the choke is in standby mode. In such a system the plurality of chokes can be a first choke and a second choke either of which may be operational while the other is in standby mode.

The present invention, therefore, provides in some, but not necessarily all, embodiments a method for diagnosing and controlling a choke used in wellbore operations, the method including placing a choke mechanism of a choke in a standby mode, controlling the choke mechanism with a processor, and the processor including a computer readable medium with computer executable instructions for producing instructions commanding the choke to operate to place the choke mechanism in the standby mode, to remain in standby mode, or to exit standby mode. Such a method may include one or some of the following, in any possible combination: the processor can include a computer readable medium for automatically placing the choke in standby mode and the system includes sensor apparatus for sensing conditions of the wellbore operations, the sensor apparatus for producing signals indicative of said conditions and for transmitting said signals to the processor, the sensor apparatus in communication with the processor, and the method further including with the processor, and based on said conditions, automatically placing the choke in standby mode; with the processor, commanding the choke to enter standby mode; with the processor, commanding the choke to remain in standby mode; with the processor, commanding the choke to exit standby mode; wherein the processor includes a computer readable medium with computer executable instructions for scheduling periodic operation of the choke and for then periodically operating the choke, the method further including with the processor, periodically operating the choke; wherein the system includes sensor apparatus for sensing conditions of the wellbore operations, the sensor apparatus for producing signals indicative of said conditions and for transmitting said signals to the processor, the sensor apparatus in communication with the processor, the method further including with the processor, preventing the choke from operating based on said conditions; wherein the choke includes a choke isolation valve and the method further includes determining with the processor when the choke isolation valve is in a standby mode; wherein the choke includes a choke isolation valve, a choke position sensor for determining the position of the choke mechanism, the choke position sensor in communication with the processor, and the method further including with the choke position sensor determining the position of the choke mechanism; wherein the processor has a processor memory containing diagnostic parameters for performing a choke diagnostic, the method further including with the processor, performing a choke diagnostic; producing with the processor a result based on a diagnostic performed by the system; determining with the processor whether a choke failure has occurred; predicting with the the processor that a choke failure will occur; wherein a pressure sensor for measuring pressure of fluid circulating through the wellbore is in communication with the processor, the method further including producing a signal indicative of a measured pressure of fluid with the pressure sensor, and determining with the processor if standby mode is appropriate in view of said measured pressure, and, if so, with the processor, entering the choke into standby mode; performing with the processor a choke mechanism speed diagnostic; and/or performing with the processor a choke mechanism position diagnostic.

The present invention, therefore, provides, in at least certain embodiments a method for diagnosing and controlling a choke used in wellbore operations, the method including placing a choke mechanism of a choke in a standby mode, controlling the choke mechanism with a processor, and the processor including for commanding the choke to operate to place the choke mechanism in the standby mode, to remain in standby mode, or to exit standby mode.

The present invention, therefore, provides, in at least certain embodiments, a method for diagnosing and controlling a choke used in wellbore operations, the method including placing a choke mechanism of a choke in a standby mode, controlling the choke mechanism with a processor system, and with the processor system selectively operating the choke and analyzing the choke's operation. Such a method may include communicating results of said analyzing to a health check system, and producing at least one health check result with the health check system.

The present invention, therefore, provides in at least certain embodiments, a computer readable medium containing instructions that, when executed, cause a processor to control operation of a choke mechanism of a choke, the choke for choking drilling fluid flow in wellbore operations, and instructions for controlling a positioner of a choke mechanism of a choke, the choke including a choke isolation valve for selectively placing the choke in standby mode, for controlling the choke isolation valve, and for selectively placing the choke in standby mode.

1. A system for diagnosing and controlling a choke, the choke used for choking in wellbore operations associated with a wellbore in the earth, the system comprising
a positioner for moving a choke mechanism of a choke,
a choke isolation valve connected to the choke for selectively isolating the choke,
a processor for controlling the positioner and for selectively commanding the positioner to move the choke mechanism while the choke is in standby mode.

2. The system of claim 1 wherein the processor automatically commands the positioner to move the choke mechanism into standby mode.

3. The system of claim 1 wherein the system includes sensor apparatus for sensing conditions of the wellbore operations, the sensor apparatus for producing signals indicative of said conditions and for transmitting said signals to the processor, the sensor apparatus in communication with the processor, and the processor includes a computer readable medium with computer executable instructions for commanding the choke to remain in standby mode based on said conditions.

4. The system of claim 1 wherein the system includes sensor apparatus for sensing conditions of the wellbore operations, the sensor apparatus for producing signals indicative of said conditions and for transmitting said signals to the processor, the sensor apparatus in communication with the processor, and the processor includes a computer readable medium with computer executable instruction for commanding the choke to enter standby mode based on said conditions.

5. The system of claim 1 wherein the processor includes a computer readable medium with computer executable instructions for scheduling periodic operation of the choke and for then periodically operating the choke.

6. The system of claim 1, wherein the processor includes a computer readable medium with computer executable instructions for diagnosing the choke.

7. The system of claim 1 wherein the system includes sensor apparatus for sensing conditions of the wellbore operations, the sensor apparatus for producing signals indicative of said conditions and for transmitting said signals to the processor, the sensor apparatus in communication with the processor.

8. The system of claim 1 wherein the system includes sensor apparatus for sensing conditions of the wellbore operations, the sensor apparatus for producing signals indicative of said conditions and for transmitting said signals to the processor, the sensor apparatus in communication with the processor, and the processor includes a computer readable medium with computer executable instructions for commanding the choke to exit the standby mode based on user input or on said conditions.

9. The system of claim 1 further comprising
a mode sensor connected to the choke for determining when the choke is in a standby mode, the mode sensor in communication with the processor.

10. The system of claim 1 further comprising
a choke position sensor connected to the choke for determining the position of the choke mechanism, the choke position sensor in communication with the processor.

11. The system of claim 1 further comprising
a processor memory in the processor and containing diagnostic instructions for performing a choke diagnostic.

12. The system of claim 1 further comprising
the processor including a computer readable medium with computer executable instructions for producing a result based on a diagnostic performed by the system.

13. The system of claim 12 further comprising
the processor including a computer readable medium with computer executable instructions for producing an analysis for determining whether a choke failure has occurred.

14. The system of claim 12 further comprising
the processor including a computer readable medium with computer executable instructions for producing an analysis for predicting that a choke failure will occur.

15. The system of claim 1 further comprising
a pressure sensor for measuring a pressure of fluid circulating through the wellbore to produce a pressure measurement, the pressure sensor in communication with the processor,
the processor including a computer readable medium with computer executable instructions for determining if said pressure measurement relative to a pre-determined pressure threshold indicates that standby mode is appropriate.

16. The system of claim 1 further comprising
the processor including a computer readable medium with computer executable instructions for performing a choke mechanism speed diagnostic.

17. The system of claim 1 further comprising
the processor including a computer readable medium with computer executable instructions for performing a choke mechanism position diagnostic.

18. A system for diagnosing and controlling a choke, the choke used for choking in wellbore operations associated with a wellbore in the earth, the system comprising
a positioner for moving a choke mechanism of a choke,
a choke isolation valve connected to the choke for selectively isolating the choke,
a processor for controlling the positioner and for selectively commanding the positioner to move the choke mechanism, the processor for diagnosing the choke, transmitting information regarding a diagnosis to a control system, and for selectively periodically activating the choke.

19. The system of claim 18 wherein the processor
enables operation of the choke during the selective periodic actuation of the choke,
confirms acceptable status of the choke,
provides notice of potential problems with the coke, and
provides notice of existing problems with the choke.

20. A system for diagnosing and controlling a choke system, the choke system used for choking in wellbore operations associated with a wellbore in the earth, the system comprising
a plurality of chokes,
valve apparatus and associated conduit apparatus for selectively operating a first choke of the plurality of chokes, while at least one non-operational choke is maintained in standby mode,
each of the chokes of the plurality of chokes further comprising
a positioner for moving a choke mechanism of a choke,
a choke isolation valve for selectively isolating the choke, and
a processor for controlling the positioner and for selectively commanding the positioner to move the choke mechanism while the choke is in standby mode.

21. The system of claim 20 wherein the plurality of chokes comprises a first choke and a second choke either of which may be operational while the other is in standby mode.

22. A method for diagnosing and controlling a choke used in wellbore operations, the method comprising
placing a choke mechanism of a choke in a standby mode,
controlling the choke mechanism with a processor, and
the processor including a computer readable medium with computer executable instructions for producing instructions commanding the choke to operate to place the choke mechanism in the standby mode, to remain in standby mode, or to exit standby mode.

23. The method of claim 22 wherein the processor includes a computer readable medium for automatically placing the choke in standby mode and the system includes sensor apparatus for sensing conditions of the wellbore operations, the sensor apparatus for producing signals indicative of said conditions and for transmitting said signals to the processor, the sensor apparatus in communication with the processor, and the method further comprising
with the processor, and based on said conditions, automatically placing the choke in standby mode.

24. The method of claim 22 further comprising
with the processor, commanding the choke to enter standby mode.

25. The method of claim 22 further comprising
with the processor, commanding the choke to remain in standby mode.

26. The method of claim 22 further comprising
with the processor, commanding the choke to exit standby mode.

27. The method of claim 22 wherein the processor includes a computer readable medium with computer executable instructions for scheduling periodic operation of the choke and for then periodically operating the choke, the method further comprising
with the processor, periodically operating the choke.

28. The method of claim 22 wherein the system includes sensor apparatus for sensing conditions of the wellbore operations, the sensor apparatus for producing signals indicative of said conditions and for transmitting said signals to the processor, the sensor apparatus in communication with the processor, the method further comprising
with the processor, preventing the choke from operating based on said conditions.

29. The method of claim 22 wherein the choke includes a choke isolation valve and the method further comprises
determining with the processor when the choke isolation valve is in a standby mode.

30. The method of claim 22 wherein the choke includes a choke isolation valve, a choke position sensor for determining the position of the choke mechanism, the choke position sensor in communication with the processor, and the method further comprising
with the choke position sensor determining the position of the choke mechanism.

31. The method of claim 22 wherein the processor has a processor memory containing diagnostic parameters for performing a choke diagnostic, the method further comprising
with the processor, performing a choke diagnostic.

32. The method of claim 22 further comprising
producing with the processor a result based on a diagnostic performed by the system.

33. The method of claim 31 further comprising
determining with the processor whether a choke failure has occurred.

34. The method of claim 31 further comprising
predicting with the processor that a choke failure will occur.

35. The method of claim 22 wherein a pressure sensor for measuring pressure of fluid circulating through the wellbore is in communication with the processor, the method further comprising
producing a signal indicative of a measured pressure of fluid with the pressure sensor, and
determining with the processor if standby mode is appropriate in view of said measured pressure, and, if so, with the processor, entering the choke into standby mode.

36. The method of claim 22 further comprising
performing with the processor a choke mechanism speed diagnostic.

37. The method of claim 22 further comprising
performing with the processor a choke mechanism position diagnostic.

38. A method for diagnosing and controlling a choke used in wellbore operations, the method comprising
placing a choke mechanism of a choke in a standby mode,
controlling the choke mechanism with a processor, and
the processor including for commanding the choke to operate to place the choke mechanism in the standby mode, to remain in standby mode, or to exit standby mode.

39. A method for diagnosing and controlling a choke used in wellbore operations, the method comprising
placing a choke mechanism of a choke in a standby mode,
controlling the choke mechanism with a processor system, and
with the processor system selectively operating the choke and analyzing the choke's operation.

40. The method of claim 39 further comprising
communicating results of said analyzing to a health check system, and
producing at least one health check result with the health check system.

41. A computer readable medium containing instructions that, when executed, cause a processor to control operation of a choke mechanism of a choke, the choke for choking drilling fluid flow in wellbore operations, and instructions for
controlling a positioner of a choke mechanism of a choke, the choke including a choke isolation valve for selectively placing the choke in standby mode,
controlling the choke isolation valve, and
selectively placing the choke in standby mode.
